(19) United States
(12) Patent Application Publication
(10) Pub. No.: US 2003/0142352 A1
(43) Pub. Date: Jul. 31, 2003

(54) Print data transfer method, printing system and printer device

(76) Inventors: Shigeki Matsunaga, Kadoma-shi (JP); Takahiko Nankou, Sanda-shi (JP); Takehito Yamaguchi, Hirakata-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/352,059

(22) Filed: Jan. 28, 2003

(30) Foreign Application Priority Data
Jan. 29, 2002 (JP) 2002-019596
Jul. 31, 2002 (JP) 2002-222715
Sep. 11, 2002 (JP) 2002-265354

(51) Int. Cl. G06F 15/00; B41J 1/00

(52) U.S. Cl. 358/1.15

(57) ABSTRACT

A printing system that allows printing of a print object stored in a device (a print data supply device) other than a print control device for issuing a print instruction is provided. For that purpose, the printing system of the present invention includes a controller (11), an HDD unit (12) and a printer unit (13). The HDD unit (12) holds a print object to be printed. The controller (11) issues a print command to the printer unit (13) for acquiring the print object stored in the HDD unit (12) for printing. The printer unit (13), by requesting the HDD unit (12) to transmit the print object according to the parameters specified by the print command, acquires the print object stored in the HDD unit (12) and prints the acquired print object.

### TECHNICAL FIELD

The present invention relates to a method for transferring print data to a printer device, and particularly to a pull-type print mode in which the printer device requests a print data supplier to supply the print data.

### BACKGROUND ART

An attempt has been made to connect a printer device to AV (Audio Visual) devices such as a digital camera and a digital broadcast receiver (STB: Set Top Box) and to print video taken and received by the AV devices directly in the printer device. However, the AV devices such as STB, being different from a personal computer, are not generally equipped with an auxiliary mass storage device such as a hard disk drive and a CD-ROM drive, and the devices that have the function to update their own firmware are few in number. Therefore, it is desirable to avoid installing different driver software for each model of the printer device to be connected. Consequently, a flexible connection mode is desirable, in which it is possible to connect freely-selected AV devices and the printer device for printing without installing the device-specific software if the device conforms to a specific standard.

As a measure to respond to this demand, there is AV/C Digital Interface Command Set (AV/C Protocol) defined by the 1394 Trade Association (TA). AV/C Protocol decides the minimum standard protocol for the connection of AV devices, maintains compatibility between the AV devices, and provides a framework in which each maker can individually improve the performance of the devices. Among the aforementioned AV/C Protocol, there is AV/C Printer Subunit that defines AV/C commands particularly relating to the printer device.

FIG. 1 is a sequence diagram that shows an example of communication procedure when an AV device such as a digital camera outputs an image for printing in the printer device following the existing AV/C Printer Subunit. Here, FIG. 1 shows communication sequence when a controller 900 connected by an IEEE1394 bus outputs a print object such as an image held inside the controller 900 to a printer unit (a printer device) 910, and the commands and responses for that case.

For a start, after the controller 900 acquires version information from the printer unit 910, creates a print job specified with a job identifier “job_ID” for the printer unit 910, and then establishes a logical transfer channel (asynchronous data transfer connection; Asynchronous Connection).

Then, the controller 900 specifies the print object that the controller 900 wants to output by sending an AV/C command CAPTURE to the printer unit 910, the controller 900 outputs (pushes) the specified print object to the printer unit 910 through the transfer channel.

After the printing has finished and the printer unit 910 returns the completion status ACCEPTED response to the controller 900, which disconnects the transfer channel Asynchronous Connection and polls the job status in the printer unit 910 after closing the print job.

Since the AV device outputs the print object to the printer device according to AV/C Printer Subunit in this manner, the printer device can print the print object without installing individual driver software.

However, the print command CAPTURE in above-mentioned AV/C Printer Subunit is issued based on the push-type print mode (Push Print) in which after issuing that print command, the controller outputs the print object held by the controller itself to the printer device, and does not support the pull-type print mode (Pull Print) in which the printer device itself captures a necessary print object from a necessary location (i.e., executes printing based on the data capture request from the printer device). This is the first problem.

Additionally, in a document written in HTML and so forth, a link with another print object (link path information) is described internally. This link path information may be represented by a relative path (a location of a file is indicated by a relative location from a certain reference point) other than an absolute path (a location of a file is indicated uniquely). Then, when the link path information is a relative path, the file cannot be captured using a similar method to that of the absolute path. This is the second problem.

Further, in the IEEE1394 standard, as for an address of a print data supply device, an effect of bus reset inherent in the IEEE1394 standard occurs. In other words, since the bus reset occurs every time a device on the IEEE1394 network is turned on/off and a cable is connected and disconnected, there is a risk that correct data cannot be captured when the address is reset (changed). This is the third problem.

### DISCLOSURE OF INVENTION

The present invention has been devised in view of these circumstances, and it is the first object of the present invention to provide a print data transfer method and the like that allow effective use of the capabilities of a pull-type printer device.

It is the second object of the present invention to provide a print file acquisition system and the like that allow acquisition of a file even if link path information is a relative path.

Furthermore, it is the third object of the present invention to provide a data transfer system and the like that allow acquisition of correct data even at the time of bus reset.

In order to achieve the above-mentioned first object, the present invention is a method for transferring print data between a print data supply device and a printer device which are connected to each other via a transmission channel, and the method includes: a step for requesting the printer device to print print data held by the print data supply device of which attribute information is attached to the print request; a step in which, in response to the print request, the printer device requests the print data supply device to transmit the print data based on the attribute information; and a step in which, in response to the data request, the print data supply device transmits the print data to the printer device.

Here, the printer device may receive the link path information of the data to be printed as the attribute information, and request the print data supply device to transmit the data to be printed itself and the print data which is specified with the link path information described in the data to be printed. For example, the printer device may receive the link file in which the link path information of the data to be printed, written in an XHTML-Print format or the like, is described, and request the print data supply device to transmit the print data specified with the link path information described in the received link file.

Specifically speaking from the viewpoint of IEEE1394, when receiving the AV/C printer command CAPTURE, the printer device issues the AV/C command in order to acquire the data to be printed or the data which is linked by the data to be printed, such as JPEG, PNG and text data, and receives the data via the established connection.

When either one of the link path information included in the attribute information and link path information described in the print data is a relative path indicating a location from a reference location, the reference location of the link path information may further be included in the attribute information. Also, the reference location of the link path information described in the print data may be extracted from the link path information included in the attribute information in the print request. Furthermore, the printer device may hold these reference locations until sending the completion notice in response to the print request.

The data request and the data transmission may be repeated. The connection may be established by the printer device, or may be established by a print control device other than the print data supply device and the printer device.

The attribute information may be address information for specifying the print data supply device. More specifically, the address information may be either one of Node_ID and EUI_{—}64 in IEEE1394 AV/C Standard, or may be a combination between either one of Node_ID and EUI_{—}64 in IEEE1394 AV/C Standard and Subunit_type and Subunit_ID in IEEE1394 AV/C Standard.

The attribute information may be connection information which specifies an input port on the part of the print data supply device on the connection. More specifically, the connection information may be Subunit_plug_ID in IEEE1394 AV/C Standard.

The attribute information may be type information which specifies a type of the print data supply device. More specifically, the type information may be Subunit_type in IEEE1394 AV/C Standard.

The printer device may receive the print request from a print control device other than the print data supply device, or send a completion notice in response to the print request after completing reception of data necessary for the requested printing.

The print request may include a first group of parameters which are irrelevant to the print data supply device and a second group of parameters which are relevant to the print data supply device. In this case, the print request may be one command including the first group of parameters and the second group of parameters, or may be divided into a first command including the first group of parameters and a second command including the second group of parameters.

When an address on the transmission channel is reset, a connection between the print data supply device and the printer device is restored, and then, the print request is retransmitted to the printer device, and, in response to the retransmitted print request, the printer device may resume reception of data necessary for the requested printing. Here, the retransmitted print request may be based on address information of the print data supply device obtained after bus reset.

A reference location of the link path information may be set for the print data supply device. The reference location may be set for the print data supply device by a respective connection.

When the print object acquired from the print data supply device includes link information indicating reference to another print object, the printer device may acquire the reference print object indicated by the link information for printing, by requesting the print data supply device to transmit the reference print object at the time for printing the reference print object.

Furthermore, the print data supply device may notify that the reference location is changed, with a response to the data request. Or the print data supply device includes a detachable recording medium, and may notify that the reference location is changed, using a parameter indicating that the recording medium is attached. Note that it is desirable that the reference location of the link path information is set for the print data supply device before the print request is issued to the printer device and the setting of the reference location is not changed until a completion notice in response to the print request is received.

The attribute information may include, out of the print data held by the print data supply device, first link path information which specifies a storage location of first print data to be printed with an absolute path, and a reference location of a relative path indicating a storage location of second print data which is referred to by the first print data.

It is desirable that the print data transfer method further includes a step for verifying, prior to the print request, whether or not the print data supply device which holds the print data and the printer device which prints the print data are connected to the transmission channel, and notifying a user of an error if at least one of the print data supply device and the printer device is not connected to the transmission channel.

The print request to the printer device includes an inquiry about whether the printer device has a function of requesting the print data supply device to transmit the print data, and the print data transfer method may further include a step in which the printer device responds to the inquiry. Here, when the printer device responds to the inquiry that the printer device does not have the function, the print data supply device may transmit the print data to the printer device without receiving the data request from the printer device. In addition, the print data transfer method may further include a step for notifying a user of an error when the printer device responds to the inquiry that the printer device does not have the function and only the printer device having the function can print print data to be printed.

In other words, the print data transfer method may further include a printing type determining step for inquiring, prior to the print request, status of at least one of the print data supply device and the printer device, and determining whether pull-type printing is carried out or push-type printing is carried out depending on the response to the inquiry, wherein in the pull-type printing, the printer device prints the print data while requesting the print data from the print data supply device, and in the push-type printing, the printer device prints the print data transmitted from the print data supply device without requesting the print data. For example, in the printing type determining step, a size of a data reception buffer included in the printer device is compared with a size of print data to be printed, and when the size of the data reception buffer is larger than the size of the print data, it is determined that the push-type printing is carried out, and when the size of the data reception buffer is not larger than the size of the print data, it is determined that the pull-type printing is carried out.

The present invention can be realized not only as the print data transfer method as mentioned above, but also as a printing system including a print control device, a print data supply device and a printer device that execute this print data transfer method, these respective devices individually, or a program that has a general purpose computer such as a personal computer execute and function the characteristic operations. And the program can, of course, be distributed via a computer readable recording medium such as CD-ROM or a transmission medium such as the Internet.

Furthermore, in order to achieve the above-mentioned second object, the print file acquisition system according to the present invention includes: a storage unit operable to store link path information which specifies a storage location of a print file; a conversion unit operable to convert a relative path into an absolute path when all or a part of the link path information acquired from the storage unit is the relative path, the relative path indicating a relative location of the print file from a predetermined reference location and the absolute path indicating an absolute location of the print file; and an acquisition unit operable to acquire the print file, the print file being able to be specified with the absolute path obtained by the conversion by the conversion unit.

In addition, in order to achieve the above-mentioned third object, the print data transfer system according to the present invention includes a print data supply device and a printer device which are connected to each other via a transmission channel, for transferring print data from the print data supply device to the printer device, and the system further includes: a network information acquisition unit operable to acquire network connection information of the print data supply device and the printer device after bus reset, when a connection is restored between the print data supply device and the printer device for resuming print data transfer after the bus reset; a connection restoration unit operable to restore the connection for the print data transfer between the print data supply device and the printer device based on the network connection information obtained from the network information acquisition unit; a print request retransmission unit operable to retransmit a print request based on the network connection information obtained from the network information acquisition unit; and an acquisition unit operable to acquire a print object based on the print request retransmitted by the print request retransmission unit.

Further Information about Technical Background to this Application

The following applications are incorporated herein by reference:

Japanese Patent Application No. 2002-019596 filed Jan. 29, 2002;

Japanese Patent Application No. 2002-222715 filed Jul. 31, 2002;

Japanese Patent Application No. 2002-265354 filed Sep. 11, 2002.

### BRIEF DESCRIPTION OF DRAWINGS

These and other objects, advantages and features of the invention will become apparent from the following description thereof taken in conjunction with the accompanying drawings that illustrate a specific embodiment of the invention. In the Drawings:

FIG. 1 is a communication sequence diagram showing a conventional print procedure.

FIG. 2 is a diagram showing a system model of the printing system in the embodiments of the present invention.

FIG. 3 is a diagram showing a communication sequence in the system model shown in FIG. 2.

FIG. 4 is a diagram showing a detailed communication sequence of a phase “object push” shown in FIG. 3.

FIG. 5A shows the AV/C command frame of the conventional print command CAPTURE based on push-type printing. FIG. 5B shows the AV/C command frame of the command CAPTURE REF according to the present invention, which allows both push-type and pull-type printing, and FIG. 5C shows the AV/C command frame of the command CAPTURE REF according to the present invention, which allows pull-type printing only.

FIG. 6 is a command frame of the command SEND FILE in AV/C Camera Storage Subunit.

FIG. 7 is one (device verification phase) of the detailed flowcharts of the communication sequence (Communication Sequence 1) shown in FIG. 3.

FIG. 8 is one (version verification phase) of the detailed flowcharts of the communication sequence (Communication Sequence 1) shown in FIG. 3.

FIG. 9 is one (job creation phase) of the detailed flowcharts of the communication sequence (Communication Sequence 1) shown in FIG. 3.

FIG. 10 is one (connection establishment phase) of the detailed flowcharts of the communication sequence (Communication Sequence 1) shown in FIG. 3.

FIG. 11 is one (print trigger phase) of the detailed flowcharts of the communication sequence (Communication Sequence 1) shown in FIG. 3.

FIG. 12 is one (file transfer phase) of the detailed flowcharts of the communication sequence (Communication Sequence 1) shown in FIG. 3.

FIG. 13 is one (disconnection phase) of the detailed flowcharts of the communication sequence (Communication Sequence 1) shown in FIG. 3.

FIG. 14 is one (job closure phase) of the detailed flowcharts of the communication sequence (Communication Sequence 1) shown in FIG. 3.

FIG. 15 is one (device verification -phase) of the detailed flowcharts of the communication sequence (Communication Sequence 2) shown in FIG. 3.

FIG. 16 is one (version verification phase) of the detailed flowcharts of the communication sequence (Communication Sequence 2) shown in FIG. 3.

FIG. 17 is one (job creation phase) of the detailed flowcharts of the communication sequence (Communication Sequence 2) shown in FIG. 3.

FIG. 18 is one (connection establishment phase) of the detailed flowcharts of the communication sequence (Communication Sequence 2) shown in FIG. 3.

FIG. 19 is one (print trigger phase) of the detailed flowcharts of the communication sequence (Communication Sequence 2) shown in FIG. 3.

FIG. 20 is one (file transfer phase) of the detailed flowcharts of the communication sequence (Communication Sequence 2) shown in FIG. 3.

FIG. 21 is one (disconnection phase) of the detailed flowcharts of the communication sequence (Communication Sequence 2) shown in FIG. 3.

FIG. 22 is one (job closure phase) of the detailed flowcharts of the communication sequence (Communication Sequence 2) shown in FIG. 3.

FIG. 23 is a flowchart showing an example of print operation of a printer unit.

FIG. 24 is a flowchart showing another example of the print operation of the printer unit.

FIG. 25 is a flowchart showing still another example of the print operation of the printer unit.

FIG. 26 is an explanatory diagram of function blocks of the printer unit.

FIG. 27 is a diagram showing an example of a print object to be printed (an image).

FIG. 28 is a tree showing a relationship between the elements of the print object shown in FIG. 27.

FIG. 29 is a flowchart showing the print operation of the printer unit.

FIG. 30 is a diagram showing an illustration of the print operation of the printer unit.

FIG. 31 is one (device verification phase) of the detailed flowcharts of the communication sequence in the case where the printer unit has a function as an AC controller.

FIG. 32 is one (version verification phase) of the detailed flowcharts of the communication sequence in the above case.

FIG. 33 is one (job creation phase) of the detailed flowcharts of the communication sequence in the above case.

FIG. 34 is one (print trigger phase) of the detailed flowcharts of the communication sequence in the above case.

FIG. 35 is one (Node_ID search phase) of the detailed flowcharts of the communication sequence in the above case.

FIG. 36 is one (connection establishment phase) of the detailed flowcharts of the communication sequence in the above case.

FIG. 37 is one (file transfer phase) of the detailed flowcharts of the communication sequence in the above case.

FIG. 38 is one (disconnection phase) of the detailed flowcharts of the communication sequence in the above case.

FIG. 39 is one (job closure phase) of the detailed flowcharts of the communication sequence in the above case.

FIG. 40 is a diagram showing a data structure of a Job_ID argument.

### BEST MODE FOR CARRYING OUT THE INVENTION

The present embodiments of the present invention will be explained below with reference to the figures.

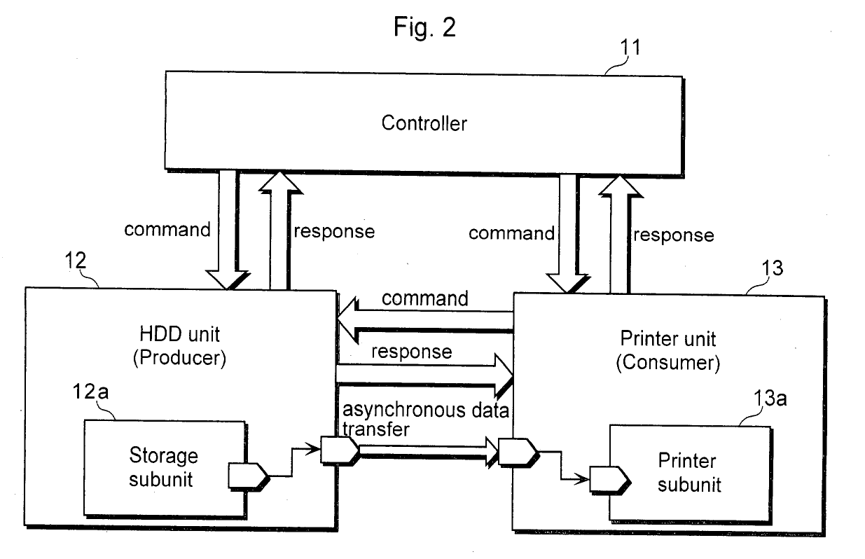

FIG. 2 is a diagram that shows a system model of a printing system according to the present embodiments. This system model is made up of a controller 11, an HDD unit 12 and a printer unit 13 which are connected to each other by an IEEE1394 bus. The basic structure of the system model is same as that of the conventional system model defined by IEEE1394, but the present system model is characterized in that an operation peculiar to a pull-type printer device (command sequences between the HDD unit 12 and the printer unit 13) is added.

The controller 11 is a device such as STB which implements a connection management function on the IEEE1394 bus. The HDD unit 12 is a hard disk drive or the like, which corresponds to a data transmission device (Producer) on a bus, and has in itself a storage subunit 12a that holds transmission data. The printer unit 13 is a printer or the like, which corresponds to a data reception device (Consumer) on the bus, and has in itself a printer subunit 13a that prints received data.

Each unit corresponds to an AV device, while a subunit corresponds to what controls the functions of the AV device (a virtual function unit). A combination of the subunits becomes a unit and the function units to be included in the unit are decided as necessary. Additionally, the subunit is a virtual function unit and does not necessarily agree with the hardware structure.

The feature in FIG. 2 is, as is shown in the exchange of data (commands and responses) between the HDD unit 12 and the printer unit 13, that not only the controller 11 or the like pushes the print object to the printer unit 13 for printing but also the printer unit 13 can pull the print object from the HDD unit 12 for printing.

Note that the print object is transmitted through an asynchronous data transfer connection (Asynchronous Connection) which has been already established. When the present embodiments are explained as controller-subunit models according to the IEEE1394 AV/C standard, the controller 11 is a controller for the printer subunit 13a in the printer unit 13. Additionally, when the HDD unit 12 pushes the print object to the printer unit 13 for printing according to the instruction of the controller 11 as in the case of the existing push-type printing, the controller 11 becomes a controller for the storage subunit 12a in the HDD unit 12. Furthermore, when the printer unit 13 pulls the print object from the HDD unit 12 during print processing as in the case of the pull-type printing which can be realized in the present embodiments, the printer unit 13 becomes a controller for the storage subunit 12a in the HDD unit 12. In this case, the printer subunit 13a itself or a module other than the printer subunit 13a fulfills the role of the controller internally.

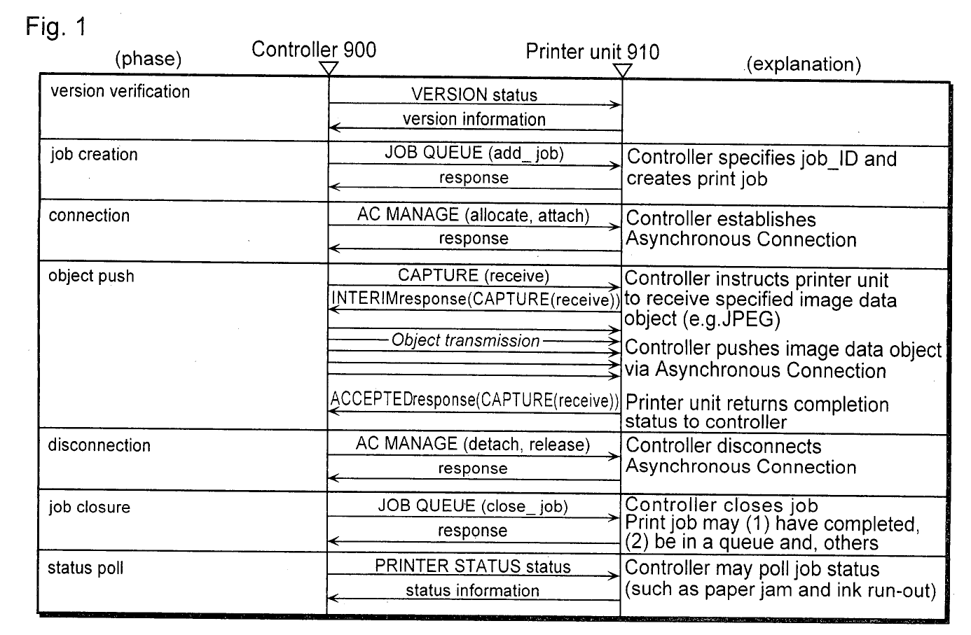

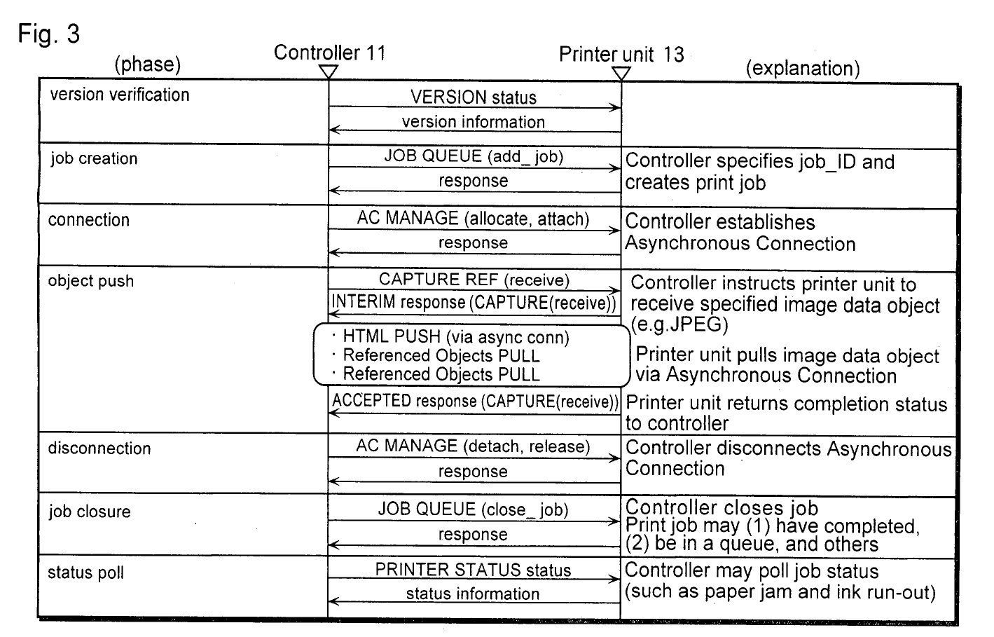

FIG. 3 is a diagram that shows communication sequence in the system model shown in FIG. 2, and corresponds to FIG. 1 of the prior art. FIG. 3 is different from FIG. 1 in the communication in the phase “object push”. In the communication sequence of FIG. 3, the controller 11 issues the command CAPTURE REF, instead of the command CAPTURE used in the sequence of FIG. 1, to the printer unit 13, and according to the parameters of that command CAPTURE REF, the push-type or pull-type transfer and printing of the print object are executed. This is a different point from the sequence in FIG. 1.

The command CAPTURE REF corresponds to an extended command CAPTURE that has additionally a function for enabling pull-type printing as well as follows the functions of the conventional command CAPTURE. Since this command CAPTURE REF includes reference to the print object (the parameters that show the location of the print object, namely link path information) placed in the different device (unit and subunit) from the device that has issued this command CAPTURE REF, the printer unit 13 which received this command can execute a pull operation of the print object. In other words, it becomes possible for the controller 11 to instruct the printer unit 13 that is a different device from the controller 11 to print the data on the HDD unit 12 that is a different device from the controller 11 and the printer unit 13.

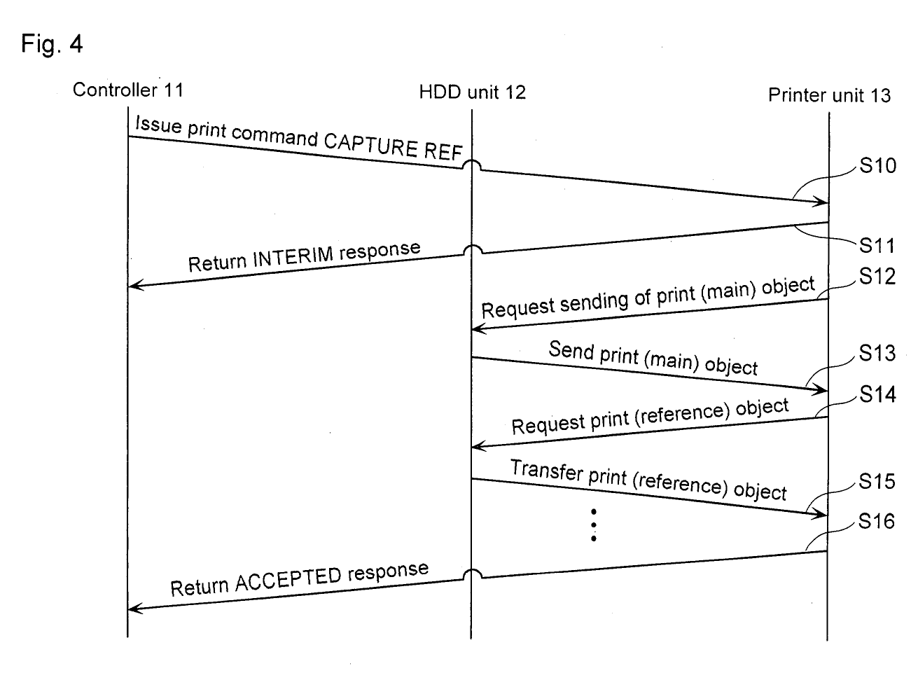

To be more specific, in the phase “object push” in FIG. 3, the communication sequence shown in FIG. 4 is done. For a start, when the controller 11 issues the command CAPTURE REF to the printer unit 13 (Step S10), the printer unit 13 returns an INTERIM response (Step S11). Subsequently, the printer unit 13 requests the HDD unit 12 to send the beginning part of the print object or the main object that is a main component of the print object (such as an HTML file) by issuing a file send request command or the like to the HDD unit 12 (Step S12). Thereby, the main object is transferred from the HDD unit 12 to the printer unit 13 via the established Asynchronous Connection (Step S13).

The printer unit 13 executes print processing of the print main object, and when extracting the link path information during the print processing, for example, the printer unit 13 requests the HDD unit 12 to send a reference object (an image object and so forth to which a hyperlink is provided) described in the main object by issuing the file send request command to the HDD unit 12 when necessary (Step S14). In doing this, the reference object is transferred from the HDD unit 12 to the printer unit 13 though the above-mentioned connection. (Step S15).

After completing acquisition of all the print objects by repeating a transfer sequence of the main objects and the reference objects like this for necessary number of times, the printer unit 13 returns to the controller 11 a response ACCEPTED to the command CAPTURE REF (Step S16). In doing this, the processing in response to the pull-type print command CAPTURE REF is completed.

The response ACCEPTED is returned in response to the command CAPTURE REF in the phase when the reception of the data that constitutes the print job (the print main object and the reference object) becomes unnecessary for proceeding with the print processing. Therefore, it is possible to save time and trouble to reestablish the connection, which has been once cut off at the moment when a response to the command CAPTURE REF was received, for the reprocessing due to a paper jam or the like during the printing. To be more specific, when the printer unit 13 implements a function of receiving all the data that constitutes the print job and storing all of it in the printer unit 13 before the actual print processing, the printer unit 13 returns the response ACCEPTED to the command CAPTURE REF at the moment when it receives all the data that constitutes the print job. On the other hand, if the printer unit 13 implements a function of receiving the command CAPTURE REF before the sequential print processing from the print main object and of receiving the relevant data whenever necessary, it returns the response ACCEPTED to the command CAPTURE REF at the moment when it completes printing of the print object.

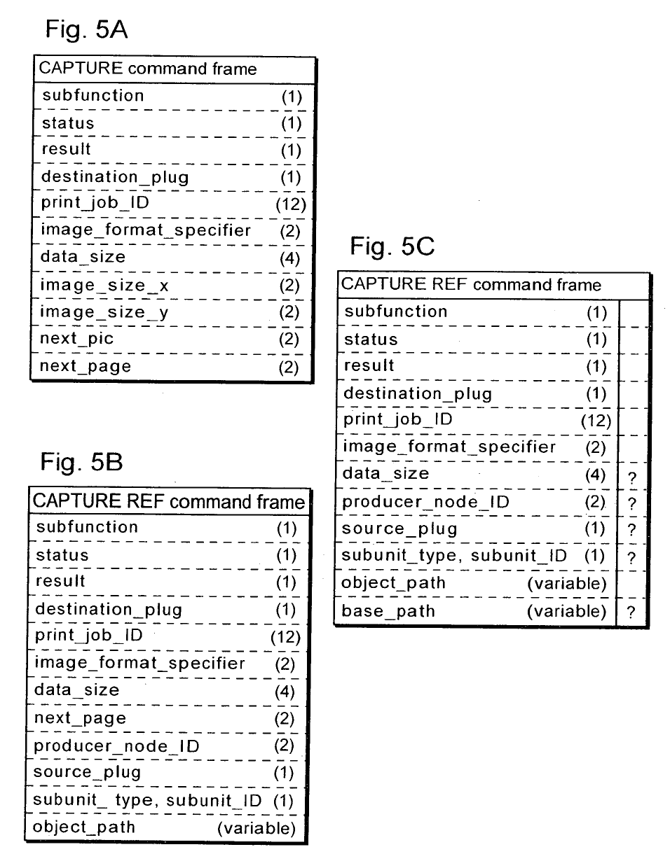

FIG. 5 is a diagram that explains a detailed command format of the command CAPTURE REF comparing with that of the conventional command CAPTURE: FIG. 5A shows the command frame of the conventional command CAPTURE based on the push-type printing; FIG. 5B shows the command frame of the command CAPTURE REF according to the present invention that allows both of the push-type and pull-type printing; and FIG. 5C shows the command frame of the command CAPTURE REF according to the present invention that allows only the pull-type printing. Here, operands (parameters added to the command) and their lengths (the number of bytes) of the AV/C command frames for both of the commands are shown. The command frames of FIG. 5B and FIG. 5C are just examples and therefore it is of course acceptable to merge the command frames of FIG. 5B and FIG. 5C or to align the parameters in any sequence.

As shown in FIG. 5A, the conventional command CAPTURE based on the push-type printing has a structure that allows to specify the following parameters as operands: a parameter “subfunction” designating a specific operation, a return parameter “status” and “result”, a parameter “destination_plug” specifying an input port for the connection on the printer unit (data reception device; consumer), a parameter “print_job_ID” specifying a print job which is subject to the command, a parameter “image_format_specifier” specifying a format of the print object such as JPEG and GIF, a parameter “data_size” specifying a data size of the print object to be transferred, a parameter “image_size_x” and “image_size_y”.specifying the number of pixels as image data, a parameter “next_pic” and “next_page” for setting information on the print object to be transferred next in the command response at the specified time “N” in 1 printing.

Contrary to this, as shown in FIG. 5B, the command CAPTURE REF that allows the pull-type printing according to the present embodiment has, as operands, five new parameters “producer_node_ID” “source_plug”, “subunit_type” and “subunit_ID”, and “object_path” in addition to the parameters which are used in the conventional command CAPTURE, “subfunction”, “status”, “result”, “destination_plug”, “print_job_ID”, “image_format_specifier”, “data_size” and “next_page”.

The parameter “producer_node_ID” is an operand that specifies the location where the print object to be pulled is placed, namely a data transmission device (producer) such as the HDD unit 12. Here, if the controller that issues this print command also serves as the data transmission device (producer) (if the controller holds the print object), it is acceptable that the controller 11 can print its own print object by setting its own value as that of this parameter “producer_node_ID”.

Additionally, the parameter “source_plug” is an operand that specifies an input port on the data transmission device (producer) in the connection. This parameter “source_plug” is one of the parameters that the controller 11 acquired when the controller 11 established the connection between the HDD unit 12 and the printer unit 13 (the phase “connection” in FIG. 3).

Futhermore, the parameter “subunit_type” and “subunit_ID” is an operand that specifies the type of data transmission device (producer) (for instance, the distinction among DSC (Digital Still Camera), STB, DTV (Digital TV), HDD and so forth) and its device number. The type of the data transmission device is to identify the type of the device when the command system, sequence and so forth on sending and receiving information change according to the differences of the characteristics and versions of the device.

Additionally, the parameter “object_path” is an operand that indicates where the print object (the main object) is stored in the layered file system in the data transmission device (producer) like the HDD and so forth. To be more specific, the link path information of the print main object is stored.

Furthermore, as shown in FIG. 5C, the command CAPTURE REF that allows only the pull-type printing according to the present embodiment has, as operands, six new parameters “producer_node_ID” “source_plug”, “subunit_type” and “subunit_ID” “object_path” and “base_path” in addition to the parameters that are used in the conventional command CAPTURE, “subfunction”, “status”, “result”, “destination_plug”, “print_job_ID”, “image_format_specifier” and “data_size”. The parameters “data_size”, “producer_node_ID”, “source_plug”, “subunit_type” and “subunit_ID” and “base_path” to which “?” is marked in FIG. 5C are the parameters that are not required to execute a print request, but have advantages such as reducing the processing load on the printer unit 13 if they exist. Consequently, it is acceptable that they do not exist in the command frame and there is no need to set values for them even if they exist (they are described in detail later). The contents of the parameters are explained below specifically.

The parameter “producer_node_ID” is an operand that specifies the location where the print object to be pulled is placed, namely the address of a data transmission device (producer) such as the HDD unit. Here, if the controller that issues this print command also serves as the data transmission device (producer) (if the controller holds the print object), it becomes possible for the controller to print its own print object by setting its own value as that of this parameter “producer_node_ID”.

The parameter “source_plug” is an operand that specifies an input port on the data transmission device (producer) in the connection. This parameter “source_plug” is one of the parameters that the controller 11 acquired when the controller 11 established the connection between the HDD unit 12 and the printer unit 13 (the phase “connection” in FIG. 3).

Furthermore, the parameter “subunit_type” and “subunit_ID” is an operand that specifies the type of data transmission device (producer) (for instance, the distinction among DSC (Digital Still Camera), STB, DTV (Digital TV), HDD and so forth) and its device number. The type of the data transmission device is to identify the type of the data transmission device when the command system, sequence and so forth on sending and receiving information change according to the differences of the characteristics and version of the device.

Additionally, the parameter “object_path” is an operand that indicates where the print object (the main object) is stored in the layered file system in the data transmission device (producer) like HDD. To be more specific, the link path information of the print main object is stored.

Furthermore, the parameter “base_path”, which will be described later in detail, is used as a reference location of a relative path in the case of solving the relative path. When the link path information of the reference object extracted from the print main object in the printer unit is the relative path, the present parameter is used to convert the link path information into an absolute path. As is described later, even if “object_path” is the relative path, the present parameter is similarly used as the reference location of the relative path to convert “object_path” into the absolute path.

Referring to the added parameters like these, the printer unit that has received this command CAPTURE REF, as a controller, requests the data transmission device (producer) to send the print objects such as the main object and the reference object for acquisition of them by specifying the subunits and the data paths thereof. In doing so, the printer unit can execute the pull-type printing. At this time, the printer unit exchanges information with the data transmission device, following the command system and sequence specified by the parameter “subunit_type”.

In the command CAPTURE REF shown in FIG. 5B, a part of the parameters, “image_size_x”, “image_size_y” and “next_pic”, used in the conventional command CAPTURE, are not used. This is because the command format shown in FIG. 5B aims at files including link information like an HTML file or the like.

In the case of aiming at raster image data not the file like this, it is acceptable to include all the parameters used in the conventional command. Additionally, in the command CAPTURE REF shown in FIG. 5C, “next_page” is not also used. This is because this parameter may be included in its command frame but it is not required.

Furthermore, the command CAPTURE REF is premised on that the reference object (the print object referred to by the main object) exists in the same unit and subunit as the main object so that the object can be transferred through the same connection path.

Here, the link path information is explained.

The link path information is, as is described above, is the information that specifies the file location uniquely, and corresponds to a file path (c: [symbol] windows [symbol] regedit.exe, for example) that specifies the file location on the local area and URL (Uniform Resource Locator) (http://www.panasonic.co.jp/products/tv/index.html, for example) that specifies the file location on the network like the Internet and so forth. In an HTML file, the link path information is described either by an absolute path or a relative path. The absolute path specifies the location of data uniquely by the information of the absolute path only, while the relative path describes a path from a certain reference location to the objective data and can specify the data location uniquely in combination with the reference location. In the case of executing the pull-type printing, there is no particular problem if all the link path information is the absolute path, but a part or all of the link path information may be the relative path. In this case, it is necessary for the printer unit 13 or the HDD unit 12 to execute a path solution that converts the relative path into the absolute path by some kind of means.

The solution of URL (Uniform Resource Locator) executed when the printer unit that has received the command CAPTURE REF pulls the HTML file placed in the data transmission device (producer) is as follows.

(1) In the Case where URL is Specified by a Relative Path

When URL is specified by a relative path, the relative path is solved and converted into the final URL (absolute path) by one of the following three methods.

For a start, the first method for solving the path in the printer unit 13 is explained.

This method is most appropriate in the case of adopting the command CAPTURE REF which omits the parameter “base_path” to simplify the command frame as shown in FIG. 5B. Compared with the second method that will be explained later, the load on the printer unit 13 increases correspondingly because of manipulation of a character string, but the first method has advantages that the length of the CAPTURE REF command frame can be saved more than the second method and that the path can be solved with more reliability than the third method because the path is solved independently for each print instruction. To be more specifically explained, for example, when the parameter “object_path” (A) in FIG. 5B is “/tmp/1394ta.html” and the specification (B) of the reference object referred to by the main object is <image border=“0”src=“Images/Q4_plug.gif” width=“210” height=“42”>, the final file path “File_path” (=(A−the name of the main object)+B) is decided to be “/tmp/Images/Q4_plug.gif”.

As just described, the point of the first method for solving the path is that the printer unit 13 derives the location of the print main object based on the parameter “object_path” of the command CAPTURE REF received from the controller 11 and solves the path using this derived location hereafter as the reference location of the relative path.

Next, the second method for solving the path in the printer unit 13 is explained.

As shown in FIG. 5C, this method is limited to the case of adopting the command CAPTURE REF whose command frame is added the parameter “base_path” that is the reference location of the relative path. But this method has advantages that the processing is easier than that of the first method and that the path can be solved with more reliability than the third method because the path is solved independently for each print instruction. To be more specific, when the parameter “object_path” (A) in FIG. 5C is a relative path, the printer unit 13 converts the relative path into the absolute path using the reference location specified by the parameter “base_path”. For example, when the parameter “object_path” is the relative path “./1394ta.html” and the parameter “base_path” is “c:/windows/”, the final file path is “c:/windows/1394ta.html” because of “base_path”+“object_path”. The printer unit 13 requests the storage subunit 12a to transmit the print main object using the absolute path derived like this. When the link path information described in the print main object is a relative path, the printer unit 13 also solves the path similarly using the parameter “base_path”. For example, when <image border=“0”src=“Images/Q4_plug.gif” width=“210” height=“42”> is described in the print main object, the link path information is “Image/Q4_plug.gif” and this is the relative path. Consequently, the final path is “c:/windows/Images/Q4_plug.gif” because of “base_path”+“Image/Q4_plug.gif”. Like this, the parameter “base_path” of the command CAPTURE REF is used to solve the path every time the link path information described in the print main object is the relative path. Consequently, the printer unit 13 holds the parameter “base_path” of the command CAPTURE REF until it completes the data reception of the print document instructed to be printed by this command.

As is just described, the point of the second method for solving the path is that the controller 11 informs the printer unit 13 of the reference location of the relative path using the parameter “base_path” of the command CAPTURE REF and the printer unit 13 solves the path using this informed reference location. Note that it is possible to save the length of the command frame of the command CAPTURE REF shown in FIG. 5C by making “object_path” a relative path as described in the example of the second method.

Lastly, the third method for solving the path in the HDD unit 12 is described.

In this method, the controller 11 sets in advance current directory information as the reference location of the relative path in the HDD unit 12. This method has advantages that it is possible to reduce the load on the printer unit compared with the first method because the HDD unit 12 solves the path and that it is possible to save the length of the command frame of the command CAPTURE REF more than the second method. To be more specifically explained, suppose that the parameter “object_path” (A) is a relative path “./tmp/1394ta.html” and the current directory information (C) is “c:/windows/”. When the printer unit 13 receives the data on HDD unit 12 that can be specified by the parameter “object_path” (A), being different from the first and second methods, the printer unit 13 does not solve the path but requests the HDD unit 12 to transmit the data using the relative path (A) directly. Receiving this request, the HDD unit 12 solves the path using the current directory information, derives the final file path as “c:/windows/tmp/1394.html” that is (C)+(A) and transmits the relevant data to the printer unit 12.

As is just described, the point of the third method for solving the path is that the controller 11 sets the reference location of the relative path as the current directory information in the HDD unit 12, which solves the path using this set current directory information.

The method for setting the current directory information is arbitrary, but it is acceptable to set the current directory information internally when the controller 11 and the HDD unit 12 are the same device, or to set up a new command for setting the current directory information of the HDD unit 12. The unit of setting the current directory information is arbitrary, but it is acceptable to set the information by the unit of the connection connected to the HDD unit, or to set it as the whole device. Especially when the HDD unit 12 can establish plural connections at the same time, it is possible to issue the requests to transmit and receive data using the relative paths at the same time via the plural connections, by setting the current directory information by the unit of the connection.

In the third method for solving the relative path using this current directory information, while the printer unit 13 is executing the print job A, the current directory information for the print job A should be set, and the current directory information in the HDD unit 12 should not be changed until the data transmission for the print job A is completed and it is detected that the following data transfer will not occur. However, unless the holding of the current directory information is guaranteed, a mechanism becomes necessary by which the printer unit 13 detects the change of the current directory information in the HDD unit 12 in order to prevent the printer unit 13 from referring to the data irrelevant to the print job A. The method for realizing this mechanism is not particularly restricted (an example will be described later).

(2) In the Case where URL is Specified by an Absolute Path

When the reference object is specified by an absolute file path (B) “File_path”, for example, <image src=“http://www.1394ta.com/1394ta_subnav-taHome.gif” usemap=“# mainNavMap” border=“0” width=“430” height=“16”>, that absolute path is used without a change. In other words, the final file path “File_path” is “http://www.1394ta.com/1394ta_subnav-taHome.gif”. In this case, the print object indicated by the URL of the absolute path is acquired directly from the local storage (cache) or the Internet.

Additionally, it goes without saying that by setting the specification (B) of the reference object on a removable medium, the print object on the removable medium is acquired.

When the storage location of the print main object is different from that of the reference object, the measures are different for each of the first to the third methods for solving the path described above. Here, the case of printing a still image stored in CD-ROM, DVD-ROM and so forth (the storage location: “D:/a.jpg”) in the pull-type print mode is explained as an example. In this case, the controller 11 creates HTML data in which the link path information of the still image is described, stores the HTML data in a different location from the above-mentioned still image (the storage location: “c:/temp/top.html”) and instructs the printer unit 13 to print the HTML data.

In the case of using the first method or the third method to solve the path, since the storage location of the HTML data and that of the still image data are different, only the method can be used in which the link path information described in the HTML data created by the controller 11 must be the absolute path, and it is impossible to make the link path information described in the HTML data a relative path.

On the other hand, in the case of using the second method to solve the path, in addition to the method in which the link path information described in the HTML data created by the controller 11 must be the absolute path, there is another method for specifying the absolute path of the HTML data (“c:/temp/top.html”) as “object_path” of the command CAPTURE REF and specifying the storage area of the still image data (“D:/”) as “base_path” that is the reference location of the relative path. In the latter method, it is possible to make the link path information described in the HTML data a relative path.

As a specific procedure by which the printer unit 13 acquires a reference object file from the HDD unit 12, it is appropriate to issue AV/C Camera Storage Subunit command “Send File” (or Camera Storage Subunit 2.0 command “Send File Partial”). In this command, the reference object is specified by the operand “file_path” and therefore, like above-mentioned (1) or (2), the reference object is specified by the path information “file_path” that is decided by the parameter “object_path” and the reference URL.

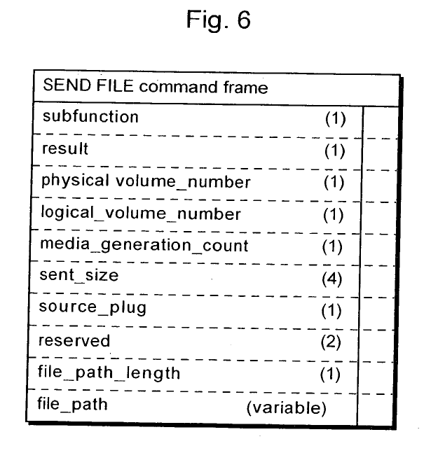

A specific explanation is given using the command frame of the command SEND FILE shown in FIG. 6. When the printer unit 12 requires the data that can be specified by “object_path”, it specifies the path of the data that is necessary for the parameter “file_path” of the command SEND FILE, similarly specifies the parameter “source_plug” of the command CAPTURE REF as the parameter “source_plug”, and issues the command SEND FILE to the storage subunit 12a.

In the existing commands SEND FILE and SEND FILE PARTIAL, the filename needs to adopt 8.3 style “filename (8 characters)”+“.”+“extension (three characters)”, the file-naming rule that conforms to MS-DOS (trademark). Consequently, upon creating of print document data, the filenames of the print main object and the reference object are named conforming to the MS-DOS (trademark). However, in the Web-Page described by the existing HTML and so forth, the filenames are often named in free length. Consequently, in order to make it possible to name the filenames of the print main object and the reference object in free length, the lengths of the filenames are extended to eliminate the restriction of the file-naming rule in the commands SEND FILE and SEND FILE PARTIAL.

Additionally, in the existing commands SEND FILE and SEND FILE PARTIAL, it is necessary to specify an absolute path as the parameter “file_path”. In the systems that use the first and second methods to solve the path, when the parameter “object_path” of the command CAPTURE REF is a relative path, the absolute path which is obtained by converting the relative path is specified as the parameter “file_path” of the command SEND FILE (or the command SEND FILE PARTIAL), and when the parameter “object_path” is an absolute path, the untouched value thereof is specified as the parameter “file_path”, so there is no effect. But in the case of adopting the third method for solving the path in the HDD unit 12 in the above-mentioned case (1), relative paths are specified as the parameters “file_path” of the commands SEND FILE and SEND FILE PARTIAL. Therefore, the commands SEND FILE and SEND FILE PARTIAL should be extended so as to specify the relative paths as the parameters “file_path”. Additionally, as is described above, as for the method for setting the current directory information in the storage subunit 12a, a new command may be added to AV/C Camera Storage Subunit, or when the controller 11 and the HDD unit 12 are the same device, the controller 11 may issue an internal order to AV/C Camera Storage Subunit.

As is described above, in the third method for solving the path, the current directory information for the print job A should be set while the printer unit 13 is executing the print job A, and the current directory information in the HDD unit 12 should not be changed until it is detected that the data transfer will not occur after the data transmission for the print job A is completed. However, in the case where plural controllers 11 exist on the network, share the one HDD unit 12, and respectively instruct the printer unit 13 to print, or in other similar cases, each controller 11 sets the current directory information of the HDD unit 12. Therefore, in this case, the holding of the current directory information is not guaranteed.

Consequently, when the controller B sets up the current directory information of the print job B in the HDD unit 12 while the printer unit 13 is processing the print job A under the instruction of the controller A, the printer unit 13 that cannot detect the situation may receive data that have nothing to do with the print job A. In order to prevent this problem, a mechanism is required for the printer unit 13 to detect the change of the current directory information in the HDD unit 12. As for the mechanism for the printer unit 13 to detect the change of the current directory information of AV/C Camera Storage Subunit, there is a method for applying the parameter “media_generation_count” in the command SEND FILE (or the command SEND FILE PARTIAL), in addition to the method of adding a new command, as mentioned above.

The parameter “media_generation_count” of AV/C Camera Storage Subunit is a parameter whose value is changed when a device equipped with AV/C Camera Storage Subunit detects insertion of a storage medium such as an SD card (trademark) into the device itself. And the controller of AV/C Camera Storage Subunit can detect the change of the storage medium by judging whether or not the parameter “media_generation_count” has changed (“media_generation_count+1”). Applying this, when AV/C Camera Storage Subunit in the HDD unit 12 changes the value of the parameter “media_genaretation_count” according to the change of the current directory information in addition to the insertion of the storage medium, the printer unit 13 can detect the change of the current directory information of the HDD unit 12.

Additionally, as for the method by which the printer unit 13 captures the reference object file from the HDD unit 12, the printer unit 13 may capture the reference object file from the HDD unit 12, using a command for a vendor-unique subunit in addition to the commands SEND FILE and SEND FILE PARTIAL in AV/C Camera Storage Subunit as mentioned above, or using a command like the command GET in HTTP (HyperText Transfer protocol).

Furthermore, at the time of bus reset, there is a possibility that “Node_ID” that is address information of each device, “destination_plug” and “source_plug” that are network connection information between the devices and so forth are reset and changed from the values before the bus reset. Therefore, in order to restart the print processing after the bus reset, it is necessary to restore the connection for a start based on the network connection information after the bus reset and then to resend a print request. The controller 11 restores the connection by obtaining “Node_ID” of the HDD unit 12 and the printer unit 13 after the bus reset and issuing the AC (Asynchronous Connection) MANAGE command accompanied with the parameter “RESTORE_PORT subfunction” based on that “Node_ID”. After that, the controller 11 can issue the command CAPTURE REF accompanied with the parameter “RESUME subfunction”. The parameters of the command CAPTURE REF at this time are set based on the information that the controller 11 has obtained similarly after the bus reset. For example, after setting the values after the bus reset in the address information such as “producer_node_ID” in CAPTURE REF (FIG. 5B and FIG. 5C) and the network connection information such as “destination_plug” and “source_plug”, the controller 11 issues the command CAPTURE REF accompanied with the parameter “RESUME subfunction”.

In response to that, the printer unit 13 can capture the print object using the command SEND FILE PARTIAL and so forth and restart the data transfer operation.

Communication sequences for realizing the pull-type printing using the command frames in FIG. 5B and FIG. 5C are explained below, as Communication Sequence 1 and Communication Sequence 2 respectively.

(Communication Sequence 1)

The communication sequence based on the command CAPTURE REF shown in FIG. 5B is explained below.

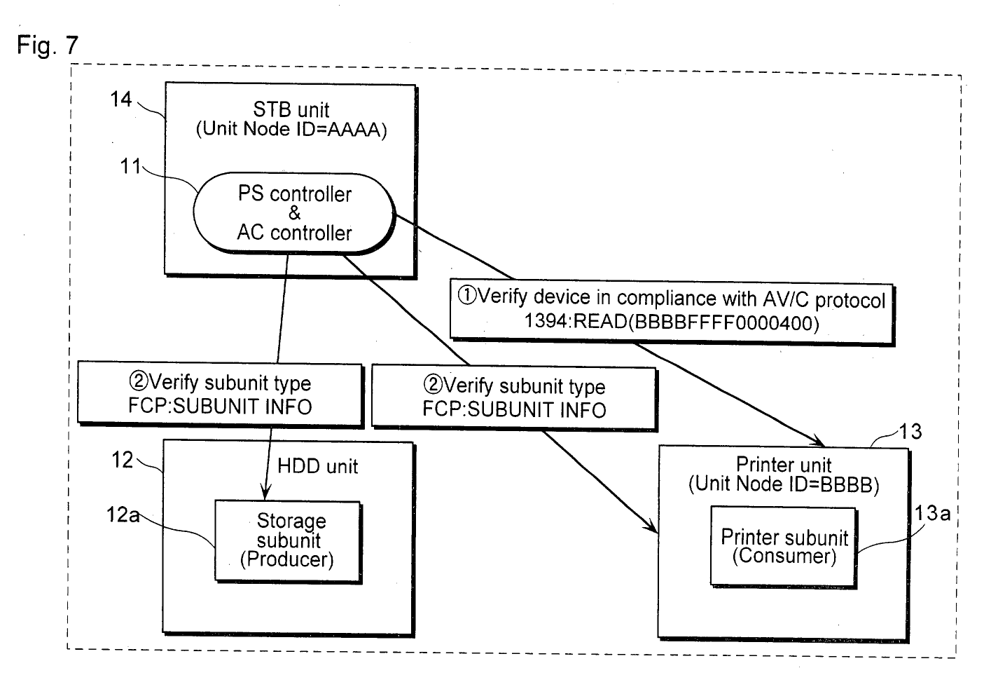

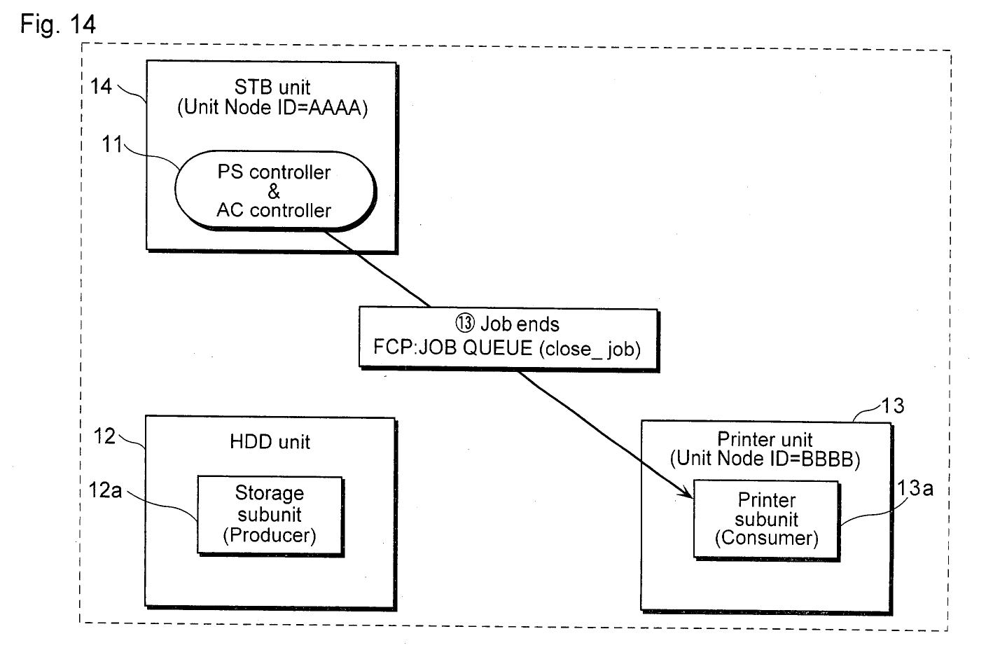

FIG. 7˜FIG. 14 are detailed flowcharts of the communication sequence shown in FIG. 3, and show exchanges of commands between three devices 11, 12 and 13. Here, the controller 11 is realized as one of the functions of the STB unit 14. Arrows indicate the issuance of the commands, and in the boxes above or near the arrows, the step numbers (\mathring{1}\mathring{2} . . . ) and the processing contents are indicated on the upper line and the protocol to which the command belongs (left) and the command type (right) are indicated on the lower line. In these figures, “PS” represents “Printer Subunit”, “AC” represents “Asynchronous Connection”, and “FCP” represents “Function Control protocol, IEC61883: Digital Interface for Consumer Electric Audio/Video Equipment” that is a protocol used as a standard for AV/C commands and the responses to them.

As shown in FIG. 7, the controller 11 first inquires the device information of the printer unit 13 as a controller for a printer subunit (PS Controller) and a controller for establishing a connection (AC Controller) (Step 1), and then inquires the subunit information of the HDD unit 12 and the printer unit 13 (Step 2).

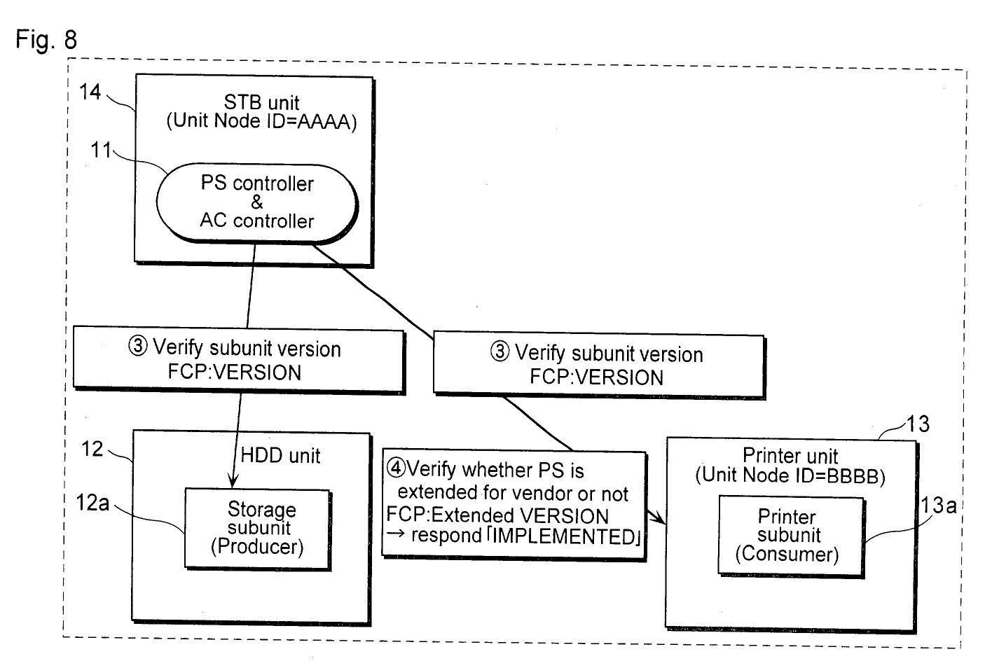

Next, as shown in FIG. 8, the controller 11 inquires the versions of the subunits of the HDD unit 12 and the printer unit 13 (Step 3), and thereby, verifies that the printer unit 13 is a printer subunit which is extended for a vendor, that is, a subunit which can execute the above-mentioned pull-type print command CAPTURE REF (Step 4).

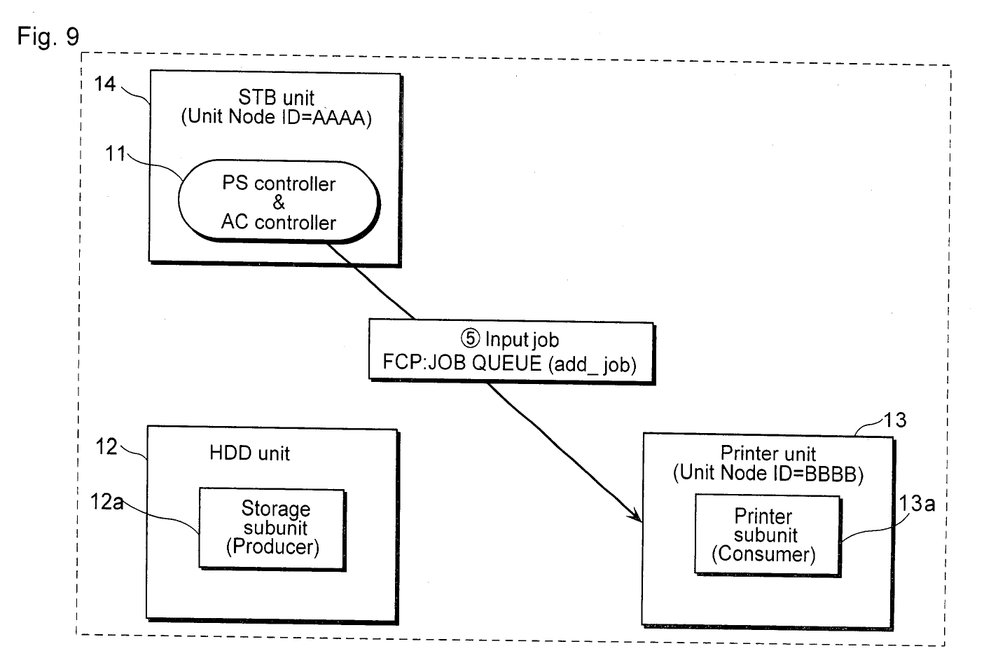

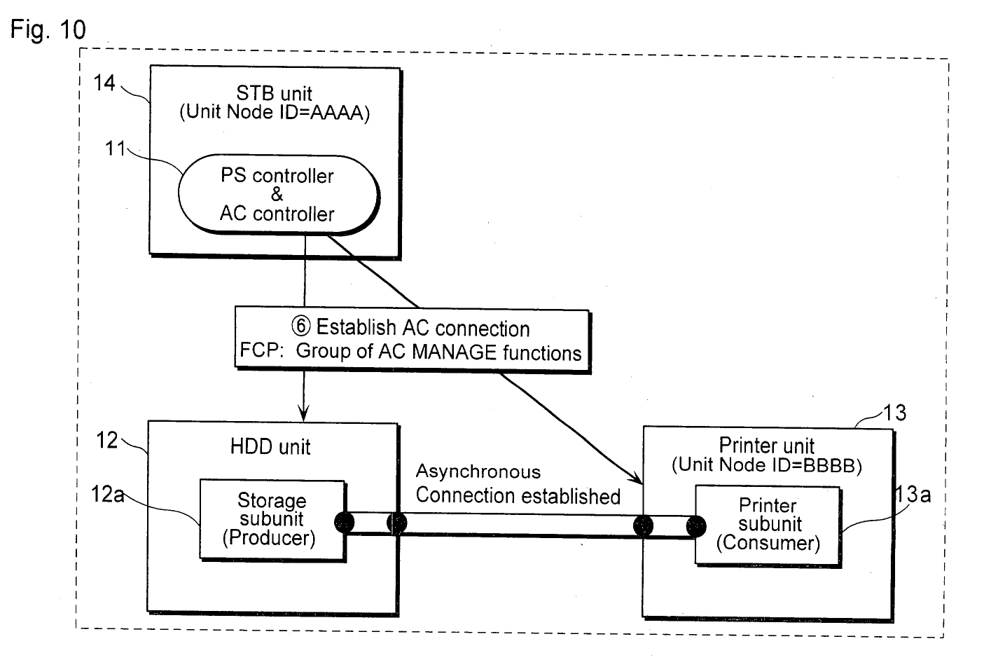

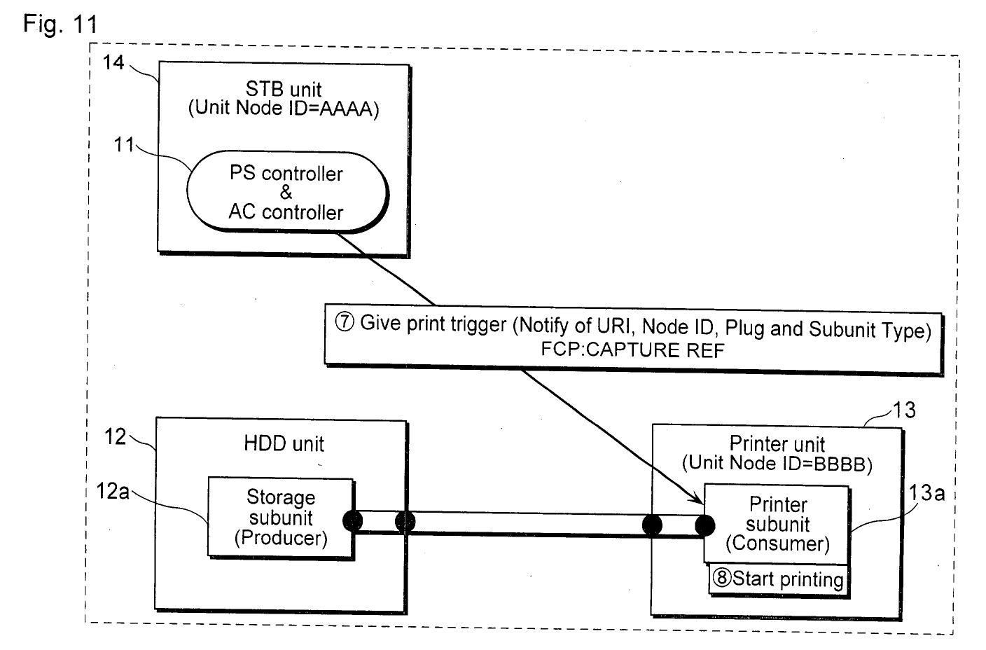

Next, after the controller 11 inputs a print job to the printer unit 13 as shown in FIG. 9 (Step 5), establishes a connection between the HDD unit 12 and the printer unit 13 as shown in FIG. 10 (Step 6), gives the printer unit 13 a trigger for printing by issuing the print command CAPTURE REF as shown in FIG. 11 (Step 7), and has the printer unit 13 start printing (Step 8).

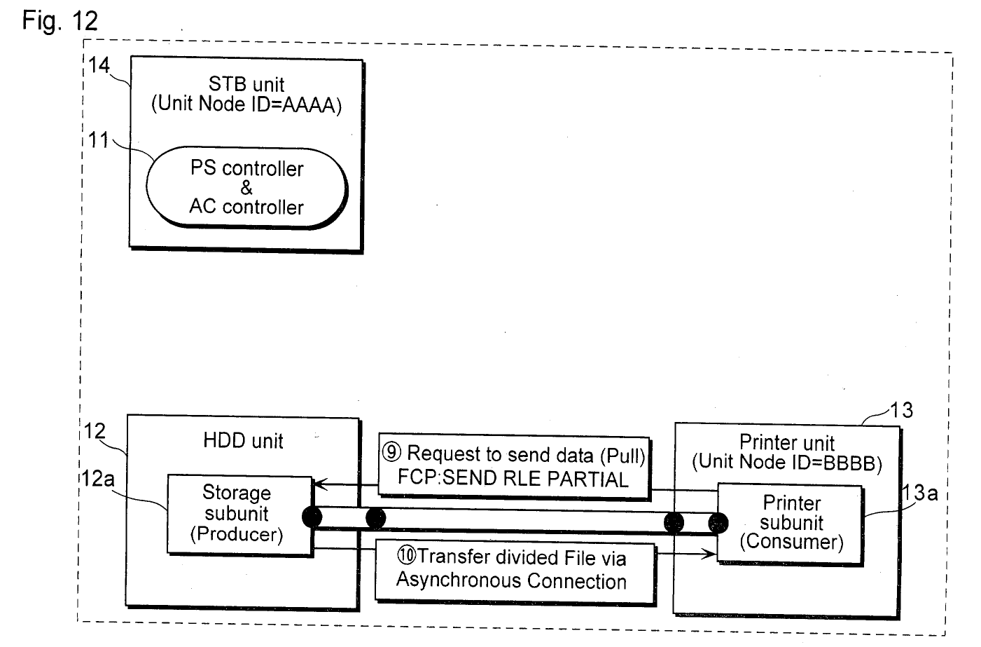

When starting printing, the printer unit 13 first requests the HDD unit 12 to send the data as shown in FIG. 12 (Step 9), acquires in sequence the print objects designated by the controller 11 (all the main objects and all the reference objects referred to by the main objects) from the HDD unit 12 via the connection, and prints them (Step 10).

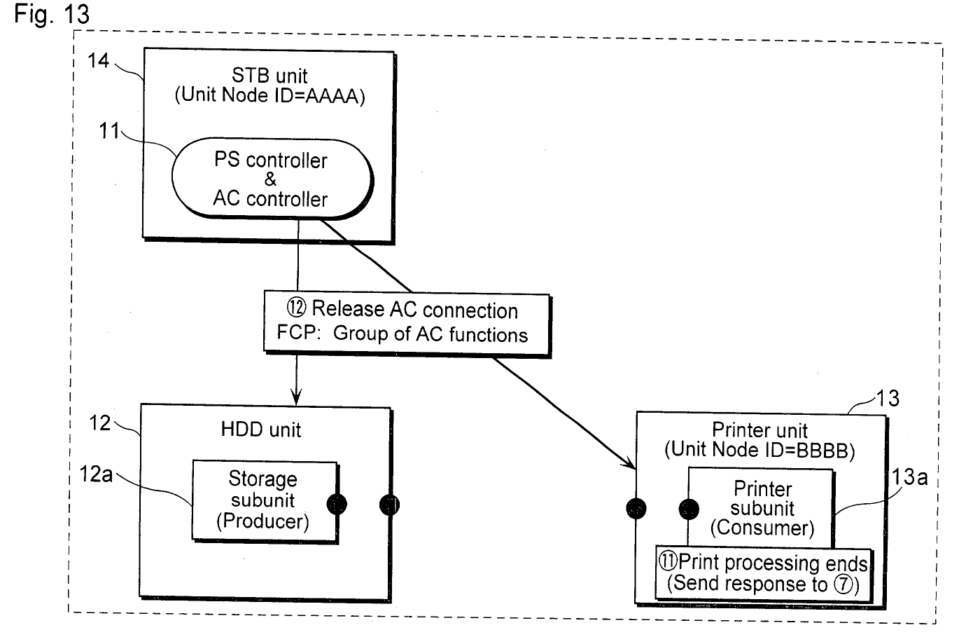

And as shown in FIG. 13, the print unit 13 ends printing (Step 11), and the controller 11 releases the connection between the HDD unit 12 and the printer unit 13 (Step 12) and notifies the printer unit 13 of the closure of the print job as shown in FIG. 14 (Step 13). In this manner, the controller 11 can have the printer unit 13 execute printing of the print objects stored in the HDD unit 12 using the pull-type print command CAPTURE REF.

(Communication Sequence 2)

The communication sequence based on the command CAPTURE REF shown in FIG. 5C is explained below.

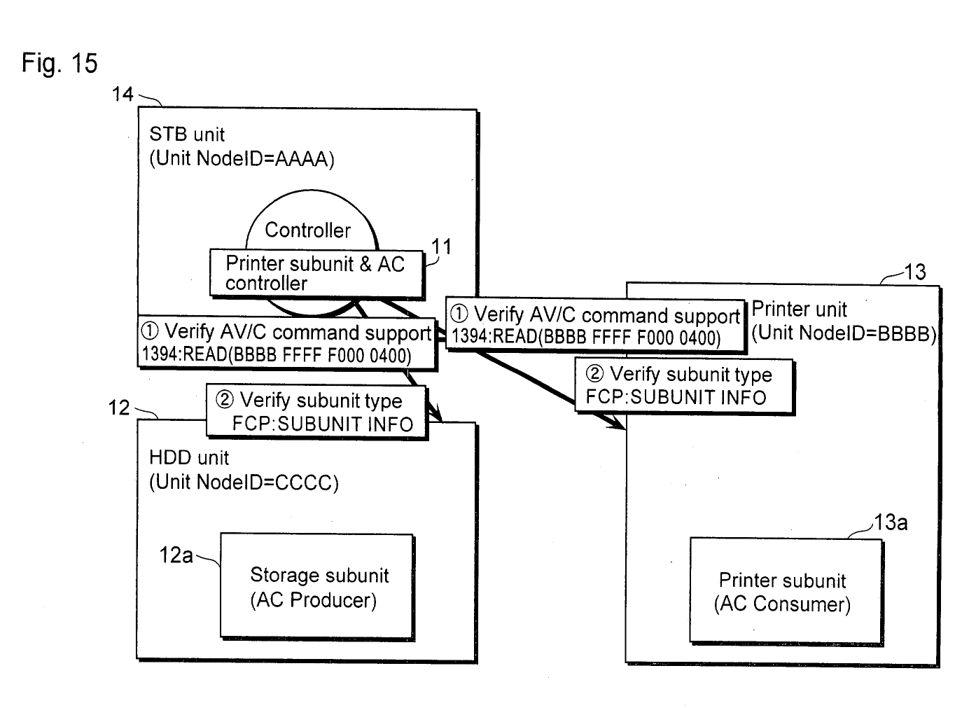

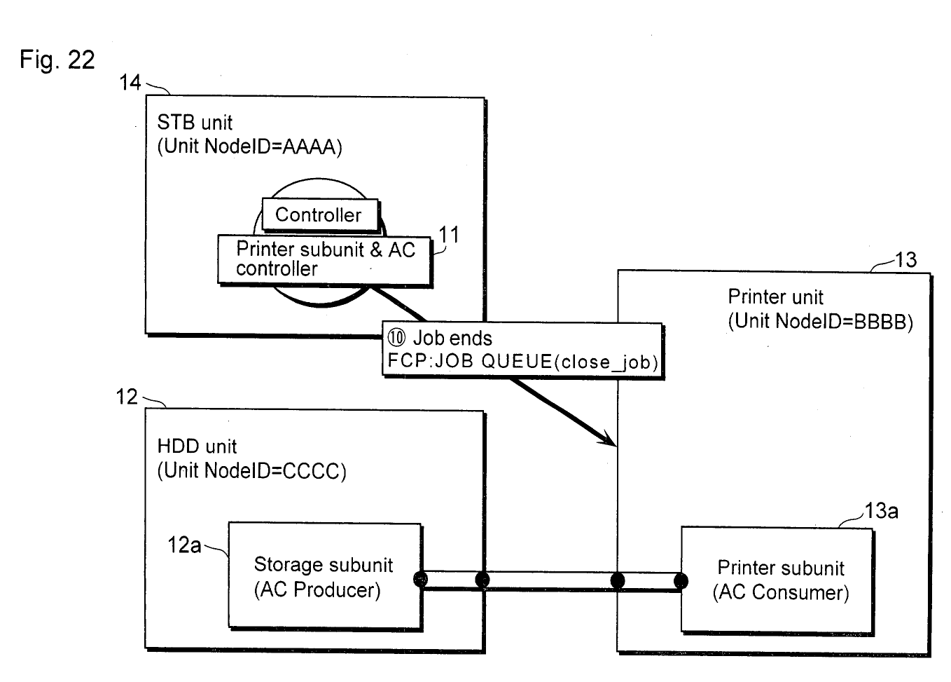

FIG. 15˜FIG. 22 are diagram showing Communication Sequence 2, and the basic sequence is same as Communication Sequence 1. FIG. 15˜FIG. 22 are same as FIG. 7˜FIG. 14 in a diagram form, and responses are omitted. Also, in FIG. 15˜FIG. 22, the STB unit 14 and the HDD unit 12 are different devices, but they may be the same device, as in the case of other embodiments in this description.

First, as shown in FIG. 15, the controller 11 collects the information of the devices on the IEEE1394 network, and verifies the information of the devices which support IEEE1394 AV/C command and “Node_ID” that is the address (location) information thereof (Step 1). Next, the controller 11 verifies which type of subunit each device has by issuing the command SUBUNIT INFO to the devices which support the AV/C command (Step 2). Through these steps, the controller 11 understands that the printer unit 13 with “Node_ID=BBBB” has the printer subunit 13a and the HDD unit 12 with “Node_ID=CCCC (Producer_Node_ID) has the storage subunit 12a (it is obvious that the STB unit 14 and the HDD unit 12 are the same devices). Since the subsequent processing cannot continue when the controller 11 cannot find the unit which has the printer subunit 13a or the storage subunit 12a, an error message is returned to the user.

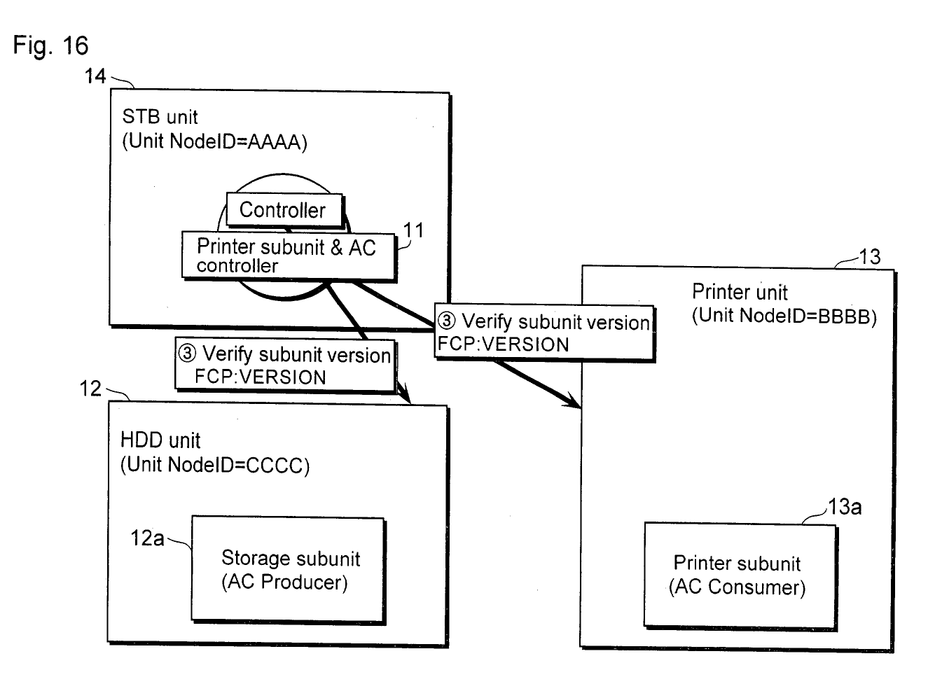

Next, as shown in FIG. 16, the controller 11 issues the command VERSION to the HDD unit 12 and the printer unit 13, and inquires their versions (Step 3). Thereby, the controller 11 understands that the printer subunit 13a is a subunit supporting the pull-type printing that can issue the command CAPTURE REF in FIG. 5C and the storage subunit 12a is a subunit that can send the print data. Also, when the third method is used for solving the path, the controller 11 understands that the storage subunit 12a is a subunit that can set the current directory information.

In above-mentioned Communication Sequence 1, the controller 11 separately issues the command Extended VERSION to the printer subunit 13a, which depends upon the contents of the standardization of the printer subunit 13a. In Communication Sequence 2, the case is described as an example where the controller 11 can understand that the printer subunit 13a supports the pull-type printing based on the response to the command VERSION issued in Step 3. In addition to the above-mentioned method, the controller 11 may understand whether or not the printer subunit 13a supports the pull-type printing by issuing the command CAPTURE REF which sets SPECIFIC INQUIRY or GENERAL INQUIRY as a command type to the printer subunit 13a for inquiry about whether the printer subunit 13a implements the command CAPTURE REF or not. Here, the case where the printer subunit 13a is a subunit which does not support the pull-type printing will be described. When the print document which the user instructs to print can be printed in the existing push-type print mode, the controller 11 may shift to the push-type print sequence subsequently and instruct the printer subunit 13a to print it according to the specifications of the existing AV/C Printer Subunit. On the other hand, when the print document instructed by the user can be printed in the pull-type print mode only, the controller 11 may return some kind of error message to the user. The error message may just indicate that this print document cannot be printed, or indicate that the printer which supports this print document is not connected on the IEEE1394 network.

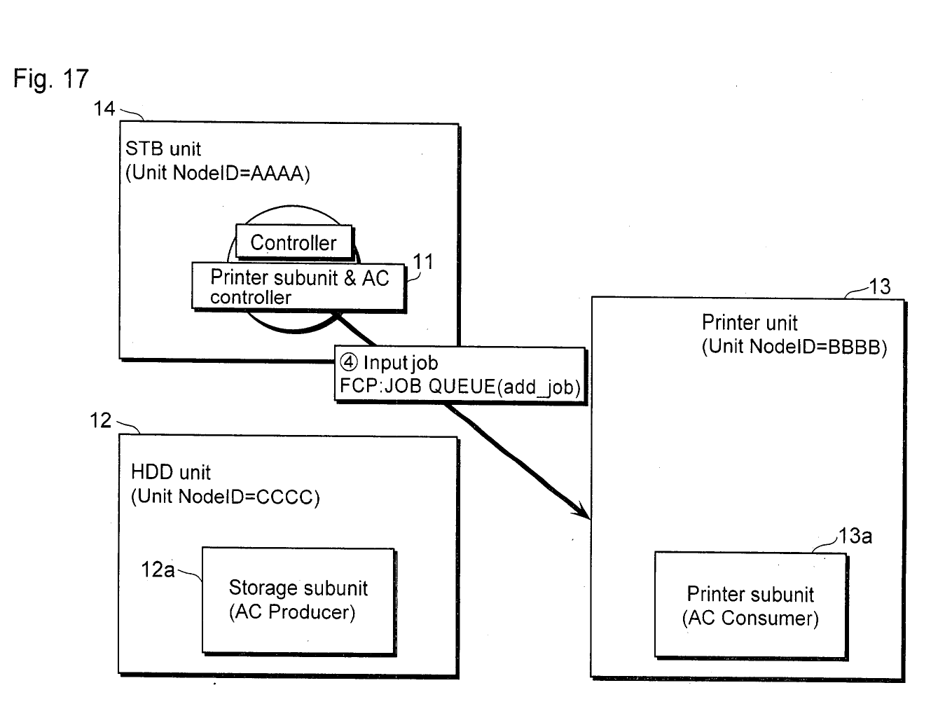

Next, as shown in FIG. 17, the controller 11 issues a print job to the printer unit 13 by issuing JOB QUEUE command “addjob” subfunction to the printer subunit 13a (Step 4). According to this command, “job_ID” corresponding to the acceptance number of the print job is shared by the controller 11 and the printer subunit 13a. This “job_ID” is used for specifying the inputted print job subsequently, and the value thereof is set for the parameter “print_job_ID” in the command CAPTURE REF shown in FIGS. 5B and 5C.

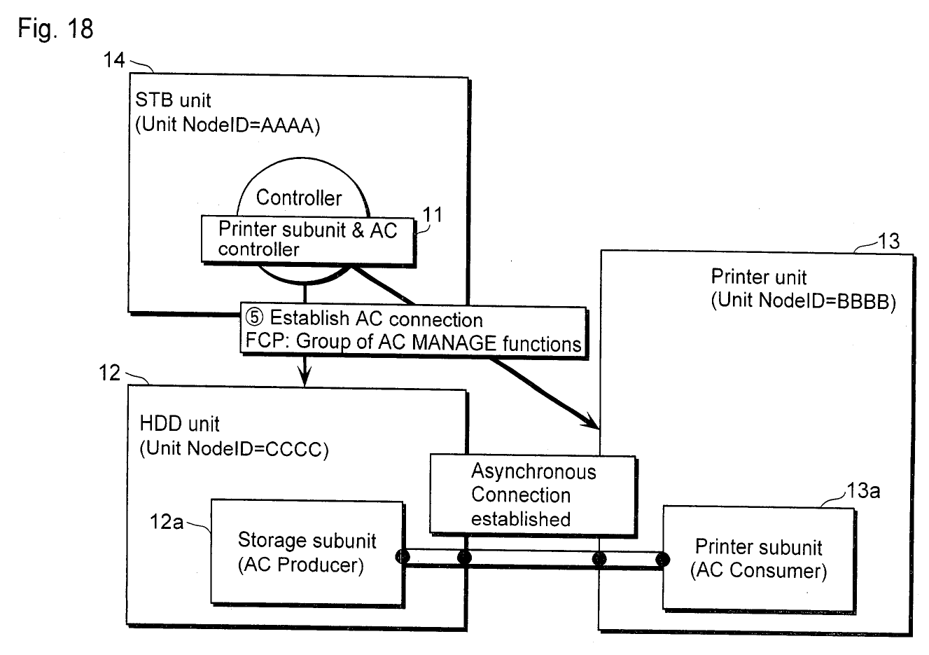

Next, as shown in FIG. 18, the controller 11 establishes a connection (AC: Asynchronous Connection) between the storage subunit 12a that is a sender of print data and the printer subunit 13a that is a receiver of the print data by issuing a group of AC MANAGE functions to the HDD unit 12 and the printer unit 13 (Step 5). The details of this group of AC MANAGE functions are described in “TA Document 1999037 AV/C Command for Management of Enhanced Asynchronous Serial Bus Connections 1.0” which is available at “http://www.1394TA.org”. With the response from this group of AC MANAGE functions, the controller 11 obtains “source_plug” that is an identifier of a connection input port (plug) on the part of the storage subunit 12a and “destination_plug” that is an identifier of a connection output port (plug) on the part of the printer subunit 13a. This “destination_plug” is used for specifying the connection for the data reception of the printer subunit 13a. The value thereof is set for the parameter “destination_plug” in the command CAPTURE REF shown in FIGS. 5B and 5C. Similarly, “source_plug” is used for specifying the connection for the data reception of the storage subunit 12a, and the value thereof is set for the parameter “source_plug” in the command CAPTURE REF shown in FIGS. 5B and 5C.

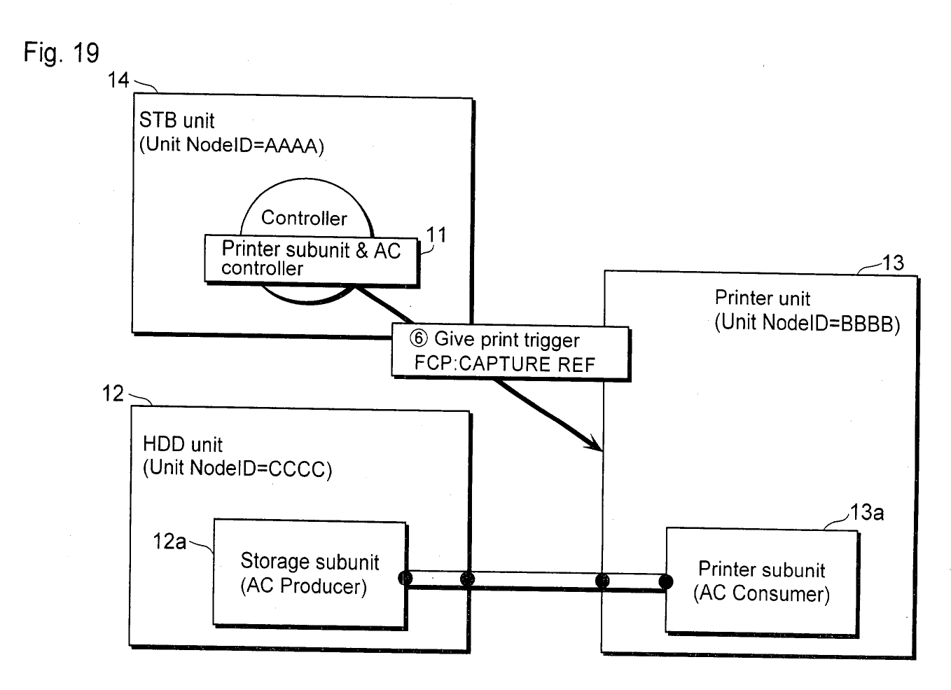

Next, as shown in FIG. 19, the controller 11 issues a print trigger, that is, the command CAPTURE REF (parameter “subfunction”=receive) shown in FIG. 5C to the printer subunit 13a and requests the printer unit 13 to print the print document which can be specified with the parameter “object_path” of the command CAPTURE REF (Step 6). The printer subunit 13a issues INTERIM response to the controller 11 in an interim manner, and returns the final response ACCEPTED (or REJECTED when an unrecoverable error occurs in midstream) to the command CAPTURE REF at the time when the print data on the storage subunit 12a has become unnecessary after going through Steps 7 and 8. When the controller 11 receives the response REJECTED, the controller 11 sends an error message to the user or perform recovery processing based on the value of the parameter “status” of the command CAPTURE REF shown in FIG. 5C.

The parameters of the command CAPTURE REF shown in FIG. 5C have been described above. The printer subunit 13a performs print processing of the print main object which can be identified with the link path information specified by “object_path”. As mentioned above, when the second method is used for solving the path, the parameter “base_path” is used. When other methods than the second one are used, since the parameter “base_path” is not required, a null value (NULL) may be specified, or the command CAPTURE REF may be defined again by deleting the parameter “base_path” itself from the command frame of CAPTURE REF. When the third method is used for solving the path, the controller 11 needs to set current directory information for the storage subunit 12a using a new command which is newly set in the storage subunit 12a or an internal function before Step 7 which will be described later. For the parameter “data_size” that is the data size of the print main object, a null value may be specified if there is no particular need, or the command CAPTURE REF may be defined again by deleting the parameter “data_size” itself from the command frame of CAPTURE REF.

The number of the commands CAPTURE REF which can be issued to the printer subunit 13a simultaneously is not particularly limited, but the following points need to be considered, though at the user's discretion, in solving the path, particularly when the third method is used for solving the path in the storage subunit 12a.

For example, when the number of the commands CAPTURE REF which can be issued to the printer subunit 13a is limited to one, the printer subunit 13a may implement a function of returning the response REJECTED by setting “busy” as the parameter “status” during the processing of one CAPTURE REF. In this case, there is no problem to use any one of the first, second and third methods for solving the path.

Next, one CAPTURE REF may be allowed to be issued to every connection which is provided to the printer subunit 13a so that the printer subunit 13a implements a function of issuing a plurality of the commands CAPTURE REF simultaneously to the printer subunit 13a. In this case, there is no problem to use the first and second methods for solving the path, but when using the third method, the current directory information needs to be settable for every connection in the storage subunit 12a, as mentioned above.

Furthermore, the number of the commands CAPTURE REF issued simultaneously may not be limited for the common use of one AC for a plurality of the commands so that the printer subunit 13a implements a function of receiving the print data which supports the respective commands CAPTURE REF in sequence. In this case, since the path cannot be solved well by the third method of solving the path in the HDD unit 12, the first or the second method needs to be used.

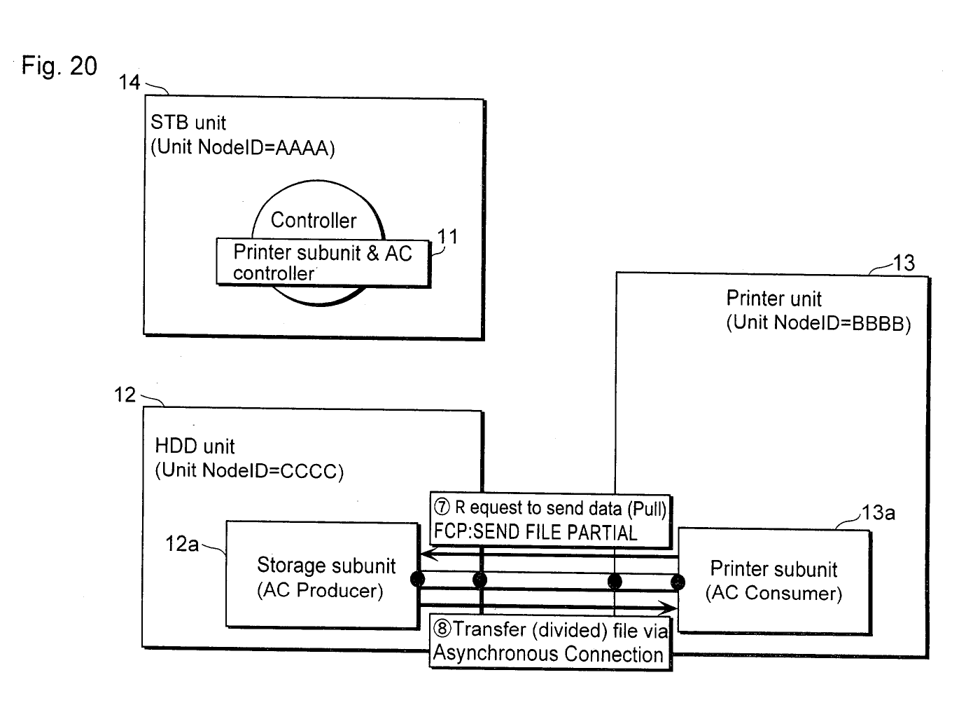

When receiving the print request in Step 6, the printer subunit 13a starts acquisition of the print main object, as shown in FIG. 20. More specifically, the printer subunit 13a issues the data send command to the storage subunit 12a (Step 7). Here, the printer subunit 13a needs to know the address (location information) of the storage subunit 12a which has the print data in order to issue the data send command. In IEEE1394, the value specified by the parameter “producer_node_ID” in the command CAPTURE REF in FIG. 5C indicates the location information of the HDD unit 12, and the parameter “subunit_type” and “subunit_ID” indicate the storage subunit 12a that is a subunit in the HDD unit 12. Furthermore, the parameter “subunit_type” also shows the command system of the storage subunit 12a. For example, when “subunit_type” is the value indicating AV/C Camera Storage Subunit, it can be understood that the print data sending can be requested by the command SEND FILE or SEND FILE PARTIAL. The case where the storage subunit 12a is AV/C Camera Storage Subunit will be explained below as an example. The printer subunit 13a issues, via the connection specified by the parameter “source_plug” of the command CAPTURE REF in FIG. 5C, the command SEND FILE PARTIAL (or SEND FILE) to send the print main object specified by “object_path” to the storage subunit 12a whose address and command system have been understood through the above steps (Step 7).

The parameters “produce_node_ID”, “subunit_type” and “subunit_ID” and “source_plug” in the command CAPTURE REF in FIG. 5C can be obtained by inquiring the status of the connection established between the storage subunit 12a and the printer subunit 13a in Step 5. The connection established in Step 5 can be specified by the parameter “destination_plug”. For more details, the printer subunit 13a first obtains “node_ID (=producer_node_ID) and “unit_plug” of the HDD unit 12 to which the printer subunit 13a is connected via the connection by inquiring internally the status of the connection which can be specified by the parameter “destination_plug”. Next, using the obtained “unit_plug”, the printer subunit 13a obtains the parameters “subunit_type”, “subunit_ID” and “subunit_plug” (=source_plug) by issuing the connection status inquiry command (AC MANAGE STATUS command), one of the above-mentioned group of AC MANAGE functions, to the HDD unit 12 whose address can be specified by “node_ID”. As mentioned above, by inquiring the status of the established connection, the parameters “producer_node_ID”, “subunit_type”, “subunit_ID” and “source_plug” can be obtained.

When obtaining the parameters “producer_node_ID”, “subunit_type”, “subunit_ID” and “source_plug”, by the above-mentioned method, a null value (NULL) may be specified for each parameter, or the command CAPTURE REF may be defined again by deleting the parameters themselves from the command frame of CAPTURE REF.

When using the first or second method for solving the path, the printer subunit 13a solves the path before issuing the data send command.

Upon receipt of the data send command, the storage subunit 12a sends the print data (the print main object in this example) to the printer subunit 13a via the established connection (AC) (Step 8). When the send command is the command SEND FILE in AV/C Camera Storage Subunit, the storage subunit 12a sends the data as it is, and when the data is SEND FILE PARTIAL in AV/C Camera Storage Subunit, it sends the data in a divided manner. When the third method is used for solving the path, the storage subunit 12a solves the path specified by the data send command based on the current directory information.

Steps 7 and 8 have been described in which the printer subunit 13a requests the storage subunit 12a to send the print main object and receives it. When the link path information indicating the data other than the print main object is described in the received print main object and the other data is the reference object required for the print processing, Steps 7 and 8 are repeated to receive the data and continue the print processing.

Since the address information “node_ID” changes when bus reset occurs during Steps 7 and 8, the restoration of the connection (AC) and the re-sending of the command CAPTURE REF that is a print trigger are necessary. The order of these processing is as follows. First, the controller 11 verifies “node_ID” after the bus reset in the HDD unit 12 and the printer unit 13, and then restores the connection using a group of AC MANAGE functions. For that purpose, there is a possibility that “source_plug” and “destrination_plug” are changed. Next, as re-sending (re-send request) of the print trigger, the controller 11 issues CAPTURE REF command Resume subfunction. When the values of the parameters “producer_node_ID” “source_plug” and “destination_plug” change after the bus reset like this, the latest value after the bus reset is set for the parameter “destination_plug” in the CAPTURE REF command Resume subfunction, and when the parameters “producer_node_ID”, “subunit_type”, “subunit_ID” and “source_plug” need to be specified in CAPTURE REF, the latest values after the but reset are also set for the parameters “producer_node_ID” and “source_plug”.

The same processing is performed when the printer subunit 13a obtains the parameters “producer_node_ID”, “subunit_type”, “subunit_ID” and “source_plug” by inquiring the status of the connection. When bus reset occurs, the controller 11 first verifies “node_ID” of the HDD unit 12 and the printer unit 13 after the bus reset, and then restores the connection using a group of AC MANAGE functions. Next, as the re-sending of the print trigger, the controller 11 issues CAPTURE REF command Resume subfunction to the printer subunit 13a. Since the connection has been already restored at the time when the printer subunit 13a receives this CAPTURE REF command Resume subfunction, the printer subunit 13a can obtain the latest values after the bus reset of the parameters “producer_node_ID”, “subunit_type”, “subunit_ID” and “source_plug” and the like by re-inquiring the status of the connection after receiving this CAPTURE REF command Resume subfunction.

The AC MANAGE function for restoring the connection after the bus reset is AC MANAGE command RESTORE_PORT subfunction, as mentioned above. This command includes “node_ID (“producer_node_ID” for the printer subunit 13a) of the device to be connected after the bus reset and the like as parameters. Therefore, when the printer subunit 13a obtains “producer_node_ID” after the bus reset by re-inquiring the status of the connection as mentioned above, the printer subunit 13a obtains it by internally inquiring the values of “producer_node_ID” and the like which were notified and stored in the AC MANAGE command RESTORE_PORT subfunction when the connection was restored. Similarly, when the printer subunit 13a needs to obtain “subunit_type”, “subunit_ID”, “subunit_plug” (=source_plug) and the like again after the bus reset, it obtains them by issuing to the HDD unit 12 again the connection status inquiry command (AC MANAGE STATUS command) that is one of the group of AC MANAGE functions based on the parameters obtained by the internal inquiry.

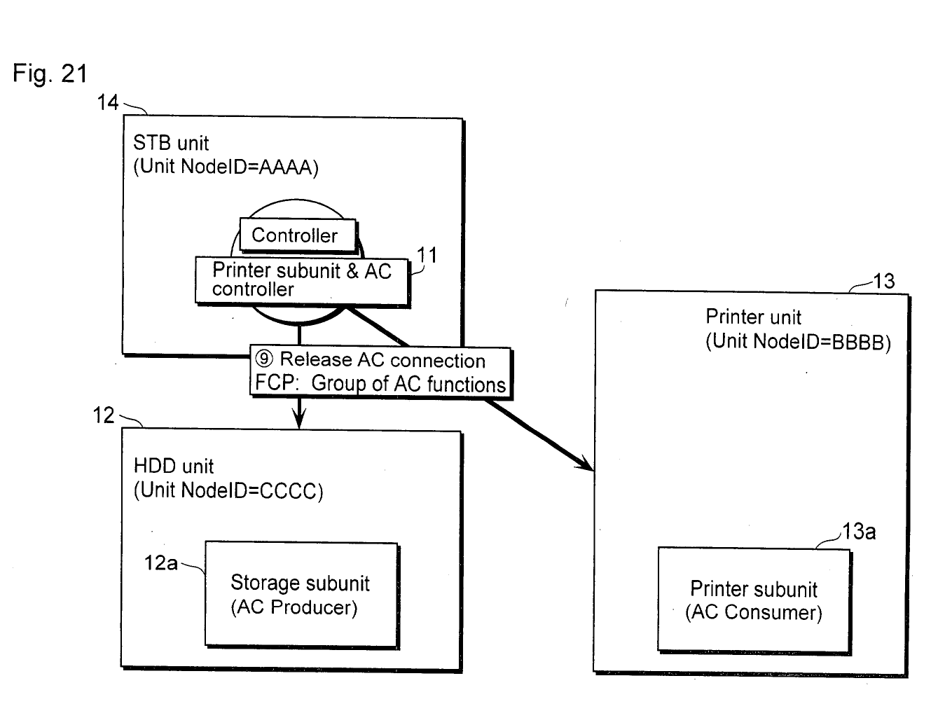

Next, upon receipt of the response of the command CAPTURE REF from the printer subunit 13a, the controller 11 releases the connection between the storage subunit 12a and the printer subunit 13a, as shown in FIG. 21, by issuing the group of AC MANAGE functions to the HDD unit 12 and the printer unit 13 (Step 9).

Lastly, the controller 11 issues JOB QUEUE command “close_job” subfunction to the printer subunit 13a (Step 10).

The printer unit 13 may start print processing at the time when it receives CAPTURE REF command “receive” subfunction in above-mentioned Step 6, or may start print processing at the time when it completes reception of all the print data that makes up the print document through Steps 7 and 8 and completes Step 10.

As described above, the controller 11 can have the printer unit 13 execute printing of the print document stored in the HDD unit 12 using the command CAPTURE REF shown in FIG. 5C.

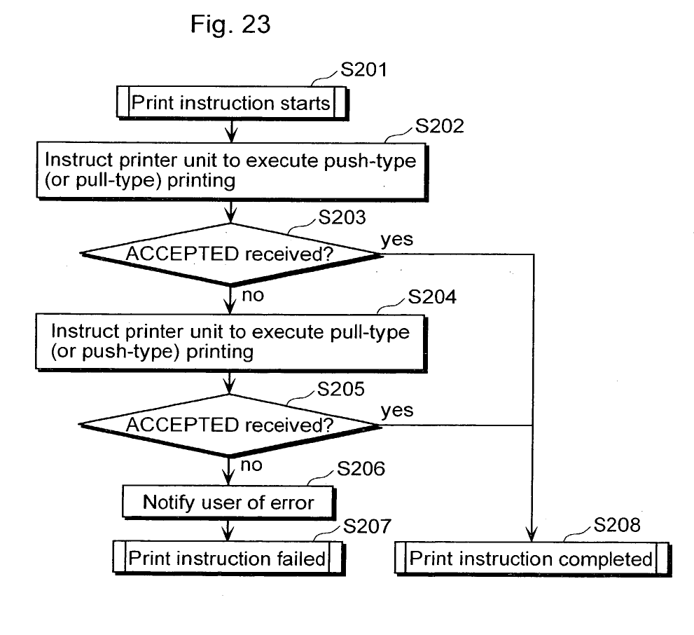

When the controller 11 is rejected its instruction of either one of push-type and pull-type printing in Step 7 in Communication Sequence 1 or Step 6 in Communication Sequence 2, it may implement a function to instruct the other type printing. This will be explained below using FIG. 23. When print instruction starts (Step S201), the controller 11 first instructs the printer unit 13 to execute push-type printing (Step S202). When the printer unit 13 does not reject (accepts) this instruction (“yes” in Step S203), the print instruction is completed (Step S208). When it rejects (does not accept) (“no” in Step S203), the controller 11 instructs the printer unit 13 to execute pull-type printing (Step S204). When the printer unit 13 does not reject (accepts) this instruction (“yes” in Step S205), the print instruction is completed (Step S208), but when the printer unit 13 rejects (does not accept) it (“no” in Step S205), the user is notified of an error (Step S206). Under this arrangement, when the printer unit 13 receives a request of printing print document which can be met in pull-type print mode but is difficult to be met in push-type print mode, it can print the print document in pull-type print mode after once rejecting the printing in push-type print mode. When the controller 11 requests push-type printing (push-type print instruction in Step S204) after its pull-type print request (pull-type print instruction in Step S202) is rejected, the same effect can be obtained.

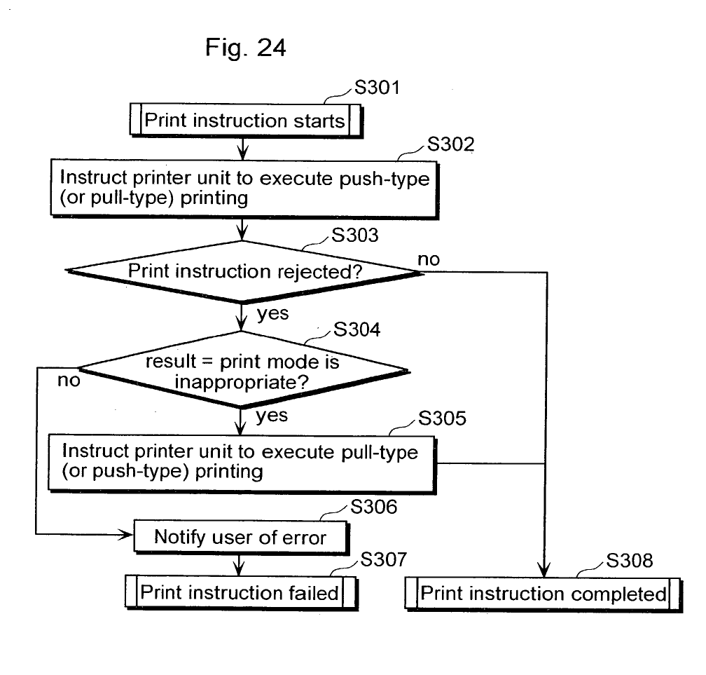

On the other hand, pull-type print mode and push-type print mode may be switched by setting a new value for instructing the controller 11 to make push-type or pull-type print request again in the status at the time when the print request is rejected. This will be explained below using FIG. 24. When print instruction starts (Step S301), the controller 11 first instructs the printer unit 13 to execute push-type (or pull-type) printing (Step S302). Upon receipt of this instruction, the printer unit 13 returns rejection to the controller 11 if the print instruction is inappropriate. Particularly when the printer unit 13 can accept the print instruction in another print mode (it can print in pull-type print mode, not in push-type print mode), it sets a value of notifying that the newly set print mode is inappropriate for the parameter “result” in the rejection response to the print instruction. When the printer unit 13 does not reject the print instruction in step S302 (“no” in Step S303), the print instruction is completed (Step S308). However, when the printer unit 13 rejects the print instruction in Step S302 (“yes” in Step S303), the controller 11 verifies the value of the parameter “result” in the response frame of the command CAPTURE (shown in FIGS. 5B and 5C), and if the value of the parameter “result” notifies that the print mode is inappropriate, it proceeds to Step S305. And if the value indicates any other status, the controller 11 notifies the user of an error. When the value of the parameter “result” notifies that the print mode is inappropriate, the controller 11 instructs the printer unit 13 to execute pull-type (or push-type) printing (Step S305) and completes the print instruction (Step S308).

In addition, the controller 11 may switch the print mode (push-type or pull-type printing) based on its judgment depending on the type and size of the print document and the capability and status of the printer. In other words, the controller 11 may inquire the capability and status information of the printer unit 13 before issuing the print request command, judge the print mode it should instruct the printer unit 13, push-type or pull-type, based on the information of the printer unit 13 and the information of the print document which should be printed, and request the printer unit 13 to print the print document based on that judgment.

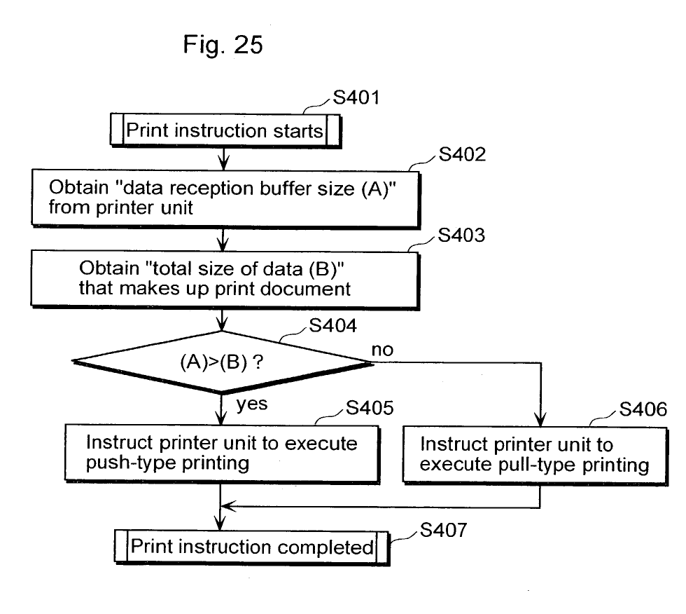

According to the present invention, methods of obtaining the capability or status information of the printer are not particularly limited. The existing command may be used, a new command for obtaining desired information may be provided if the desired information cannot be obtained by the existing command, or the existing command may be extended. An example of these methods will be explained below using FIG. 25. Assume that a command exists or a new command is provided which can inquire the data reception buffer size (A) for which the printer unit 13 can prepare for the relevant job. When print instruction starts (Step S401), in Step 7 in Communication Sequence 1 or Step 6 in Communication Sequence 2, the controller 11 first obtains the data reception buffer size (A) from the printer unit 13 using the above-mentioned command (Step S402). Next, the controller 11 acquires internally the total size of data (B) which makes up the print document which is printed in the relevant job, or obtains the total size of data (B) by inquiring it of the storage subunit (Step S403), and compares the data reception buffer size (A) and the total size of data (B) (Step S404). In the case of (A)>(B), the controller 11 judges that push-type printing is most appropriate based on the number of communication transactions, and instructs the printer unit 13 to execute push-type printing using the existing command CAPTURE (Step S405). In the case of (B)≧(A), the controller 11 judges that the printer unit 13 cannot receive all the print document even if the controller 11 instructs push-type printing, and instructs the printer unit 13 to execute pull-type printing using the command CAPTURE REF (Step S406). In this manner, the controller 11 judges depending upon the capability and status of the printer to select the best print mode (push-type printing or pull-type printing) and instructing printing in the selected mode, and completes the instruction (S407).

In the above example, the controller 11 judges based on the reception buffer size and the total size of the print document, but the present invention is not limited to those. For example, while the printer unit 13 is printing another job, the controller 11 may instruct it to execute push-type printing in order to shorten the time period for the data transfer connection being established, and transfer the data of the other job to the printer unit 13 in advance during printing of the other job. In addition, a printing system can be configured in which the best print mode is automatically selected for printing according to the judgment based on the commands for verifying the capability and status of the printer and the contents thereof.

Here, print stop (print job cancel) will be explained.

Print job is cancelled by sending JOB QUEUE command “cancel_job” subfunction to the printer subunit 13a.

Print job is issued at the time when above-mentioned Step 4 is executed. At this time, the print data has not yet transferred. When JOB QUEUE command “cancel_job” subfunction is issued in the state of Steps 4 and 5, the print job is cancelled before the print data is transferred and printed. After CAPTURE REF command “receive” subfunction was issued in Step 6, there is a possibility that the data has been transferred using the connection established between the storage subunit 12a and the printer subunit 13a. When the print job is cancelled in the state of Steps 6˜8 (including the state of receiving the reference object referred to by the print main object), there is a method of closing the print job by issuing the same JOB QUEUE command “cancel_job” subfunction as it is. However, for the purpose of one command to one job correspondence, the following implementation may be carried out. In the state when the CAPTURE REF command “receive” subfunction is in execution in the printer subunit 13a, even if the printer subunit 13a receives JOB QUEUE command “cancel_job” subfunction, it returns REJECT response with “busy” status to the JOB QUEUE command. In order to cancel the print job in this state, the controller 11 issues CAPTURE REF command “abort” subfunction and stops data transfer, and issues JOB QUEUE command “cancel_job” subfunction and cancels the print job.

Next, detailed operation of pull-type printing by the printer unit 13 will be explained taking an example. The following example shows the operation performed when print processing such as rasterization is executed while the print main object is being processed by every band and the necessary reference objects are being acquired in sequence if any.

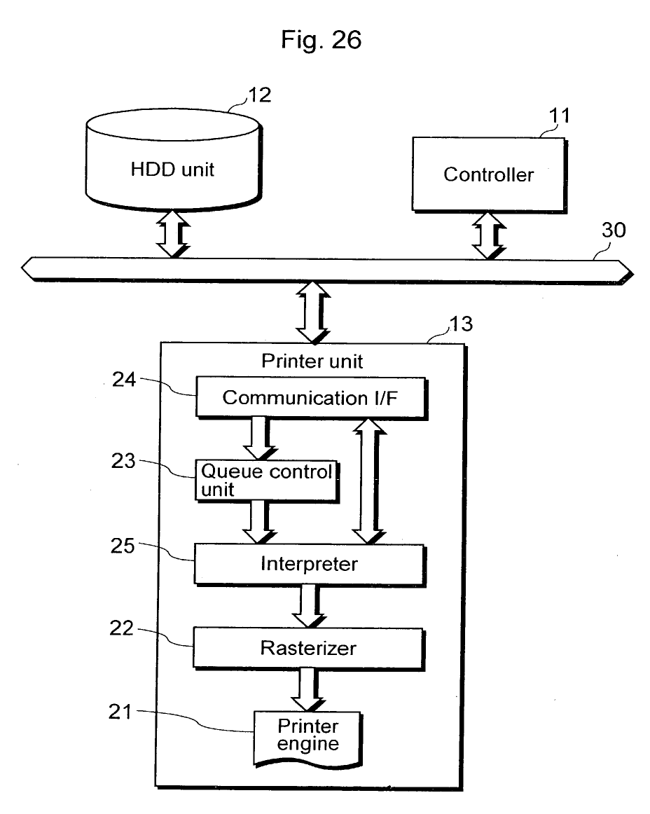

FIG. 26 is an explanatory diagram of function blocks of the printer unit 13. This figure shows the printing system in which the controller 11, the HDD unit 12 and the printer unit 13 are connected to each other by an IEEE1394 bus 30.

The printer unit 13 includes a communication I/F 24 that is an interface for connection with the bus 30, a queue control unit 23 that controls a queue for storing printer jobs, an interpreter 25 that interprets print description data and passes it to a rasterizer 22, the rasterizer 22 that performs rasterization based on the print data obtained from the interpreter, and a printer engine 21 that outputs the print description data on a recording medium in an visible manner.

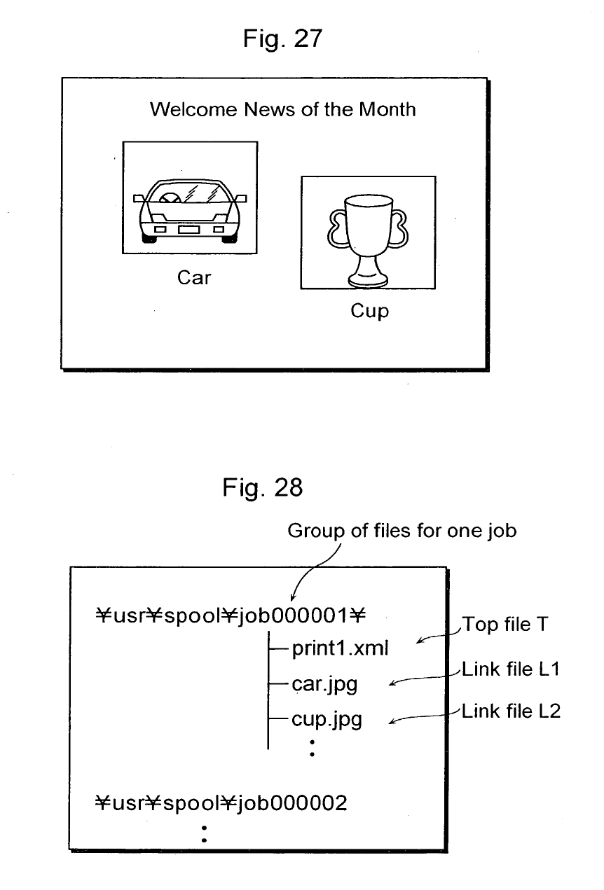

Here, assume that the print object to be printed is the data whose image is shown in FIG. 27. This image data is described in a language which can be printed in the printer (such as an XHTML format), and includes a plurality of files. The reference relationship between the files is shown in the tree of FIG. 28.

In FIG. 28, a top file T “print1.xml” is a print main object, represents the whole image data, and indicates the image layout, the character layout and size, the characters to be printed and so on. A link file L1 “car.jpg” indicates an image of a car stored in the subdirectory of the HDD unit 12, and a link file L2 “cup.jpg” indicates an image of a cup also stored in the subdirectory of the HDD unit 12. In the top file T, the link path information for the link file L1 and that for the link file L2 are described, which are respectively the reference objects for the top file T.

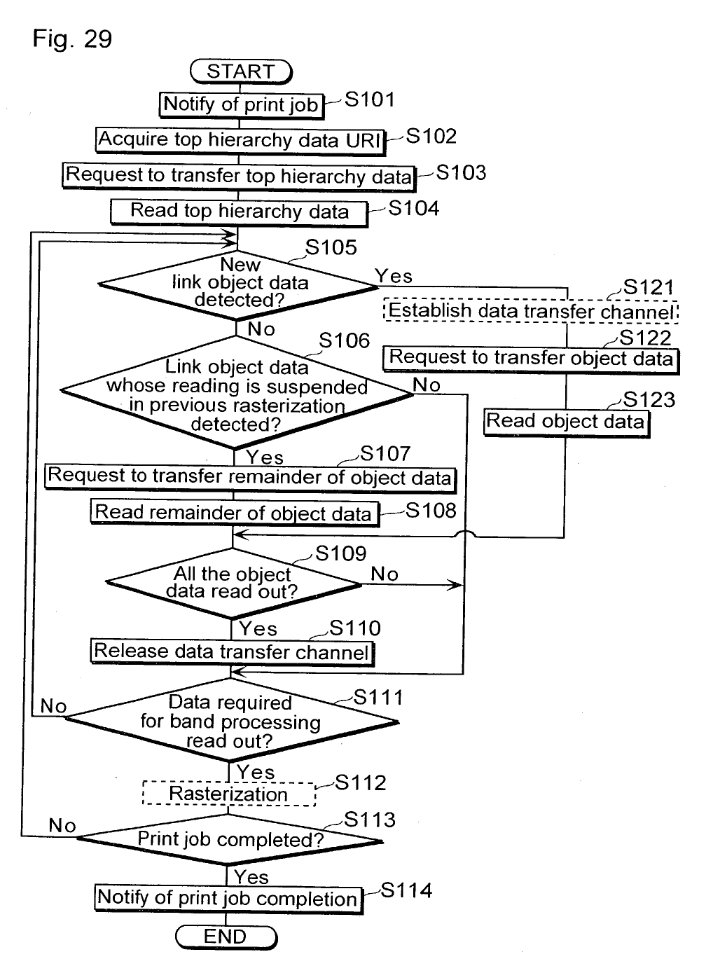

FIG. 29 is a flowchart showing the operation of the printer unit 13 for printing these print objects.

First, the controller 11 issues the command CAPTURE REF specifying the above print objects as a notice of print jobs to the printer unit 13 (Step S101). The issued print command is passed as the print jobs to the queue control unit 23 of the printer unit 13 via the bus 30. The queue control unit 23 stores the jobs and passes the job information thereof to the interpreter 25 one after another.

The interpreter 25 performs the following print processing based on the path information included in these print jobs, indicating the location of the print description data on the HDD unit 12 (URI; Universal Resource Identifies or the like).

More specifically, when determining that a signal passed from the queue control unit 23 is a print job as well as path information, the interpreter 25 instructs the communication I/F 24 to establish a channel (connection). Via the channel, the interpreter 25 passes the path information of the HDD unit 12 and requests the HDD unit 12 to transfer the top file T that is the top hierarchy data corresponding to the relevant print job (Steps S102˜S103).

In response to this request, the HDD unit 12 sends the top file T to the printer unit 13 via the bus 30 (Step S104). Note that this data transfer request may be a request to send a set of arbitrary files as single data or a request to send arbitrary amount of data at an arbitrary location (i.e., a partial request of data for one file).

When receiving the file, the interpreter 25 determines the type of the print description data, abandons unnecessary data, and passes the data to be printed to the rasterizer 22. Upon receipt of the data to be printed, the rasterizer 22 rasterizes the data, and the printer engine 21 prints the data on a recording medium.

When detecting that the link file L which is linked to the top file T exists in the above-mentioned print description data, the interpreter 25 instructs the communication I/F 24 to establish another channel than the established channel. When the new channel is established, the interpreter 25 makes a request to transfer the relevant object, and reading of the object data starts (“Yes” in Step S105˜S121˜S122˜S123). This reference object is read by every arbitrary amount of data, but the value of the amount may be set in advance, or the interpreter 25 may perform arithmetic operation of every amount required for rasterization (for example, an amount of data for several rasters) (Step S111).

Here, as shown in FIG. 28, when a plurality of object files exist, the interpreter 25 reads out the data of the above-mentioned amount to the rasterizer 22 by every relevant file at this time.

When the data amount of the object file which has been read out reaches the above-mentioned amount, the data transfer is temporarily suspended at that time and the rasterization processing is performed (Step S112 in FIG. 29). When the rasterization is completed and the next data becomes necessary, the HDD unit 12 starts the transfer of the data at the position next to the position where the transfer was suspended (“Yes” in Step S106˜S107˜S108). When the interpreter 25 completes reading of one object, the channel established as above is released (“Yes” in Step S109˜S110). Also, when all the print job is completed, the controller 11 is notified of the print completion (Steps S113˜S114).

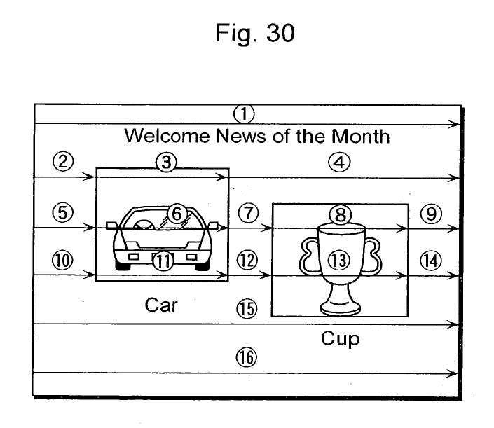

FIG. 30 shows the above-mentioned steps in a concrete manner. The following Steps 1, 2 . . . correspond to \mathring{1} \mathring{2} . . . in FIG. 30. Since the bus IEEE1394 on which a plurality of channels can be used simultaneously is used in this example, channels are established for a plurality of objects respectively as described below. But a plurality of objects data may be transferred via the same channel.

Step 1: The first line of the top hierarchy base data is rasterized.

Step 2: The second line of the top hierarchy base data is rasterized.

Step 3: An object file indicated by link information is detected during rasterization of the second line of the top hierarchy base data. The request is issued to the HDD unit 12 to transfer the object file via a transfer channel separately provided, and upon receipt of the request, the HDD unit 12 transfers the data of the file. The rasterizer performs rasterization based on this data.

Step 4: Reading of the first object file is temporarily suspended at the time when it comes to a pause, and the second line of the top hierarchy base data is rasterized.

Step 5: The third line of the top hierarchy base data is rasterized.

Step 6: The object file (which is same as that in Step 3) indicated by the link information is detected during rasterization of the third line of the top hierarchy base data. The remainder of the data of the first object file developed (rasterized) in Step 3 is requested, the object file is read and rasterized.

Step 7: Reading of the first object file is temporarily suspended at the time when it comes to a pause, and the third line of the top hierarchy base data is rasterized.

Step 8: Another object file indicated by link information than that in Step 6 is detected during rasterization of the third line of the top hierarchy base data. Another transfer channel is provided than the channel in Steps 3 and 6, and the data of the relevant object file is requested for reading and rasterization.

Step 9: Reading of the second object file is temporarily suspended at the time when it comes to a pause, and the third line of the top hierarchy base data is rasterized.

Step 10: The fourth line of the top hierarchy base data is rasterized.

Step 11: The first object file (which is same as the object file in Steps 3 and 6) indicated by the link information is detected during rasterization of the fourth line of the top hierarchy base data. The remainder of the data of the object file developed (rasterized) in Step 6 is requested for reading and rasterization.

Step 12: Reading of the first object file is completed at the time when it comes to the end, and the transfer channel is released. The fourth line of the top hierarchy base data is rasterized.

Step 13: The second object file (which is same as the object file in Step 8) indicated by the link information is detected during rasterization of the fourth line of the top hierarchy base data. The remainder of the data of the object file developed (rasterized) in Step 8 is requested for reading and rasterization.

Step 14: Reading of the second object file is completed at the time when it comes to the end, and the transfer channel is released. The fourth line of the top hierarchy base data is rasterized.

Step 15: The fifth line of the top hierarchy base data is rasterized.

Step 16: The sixth line of the top hierarchy base data is rasterized.

As described above, the printing system according to the present invention is configured for transfer of print description data by a serial bus connection so as to control (stop or retry) the transfer of the data in a format interpretable for a printer unit by every data amount which can be rasterized by the printer unit. This pull-type printing makes it unnecessary for the printer to have a large capacity of data buffer for spooling and enables the printer to pull print description data whenever necessary, which is convenient for rasterization.

Also, all the controller needs to do is to issue a job (print command). The controller can issue a print instruction without holding a print object.

Note that when it is judged that reading of base data (print main object) or receiving of a relevant part of data is impossible during Step 1˜Step 16, the processing is discontinued at that time because the subsequent processing cannot be executed.

On the other hand, when it is judged that receiving of data of an object file (a reference object) is impossible in Steps 3, 6, 8, 11 and 13, the processing may be discontinued at that time, or the processing may be continued as it is by printing for a user an image with a blank, “x” mark or the like in the relevant part of the data which could not be received.

The printing system according to the present invention has been explained based on the embodiments, but the present invention is not limited to these embodiments.

For example, the printer unit 13, instead of the controller 11, may establish a connection. In other words, when the printer unit 13 has a function as an AC controller, the printer unit 13 may establish Asynchronous Connection with the HDD unit 12. In this case, Step 6 shown in FIG. 10 (connection establishment) is replaced with Step 7 shown in FIG. 11 (print trigger). More detailed explanation is as follows.

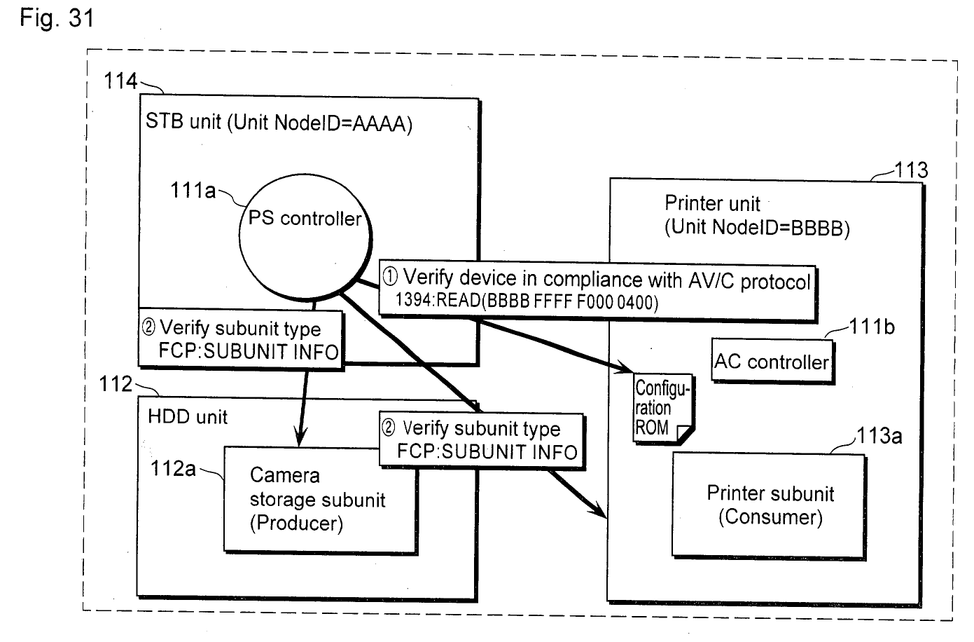

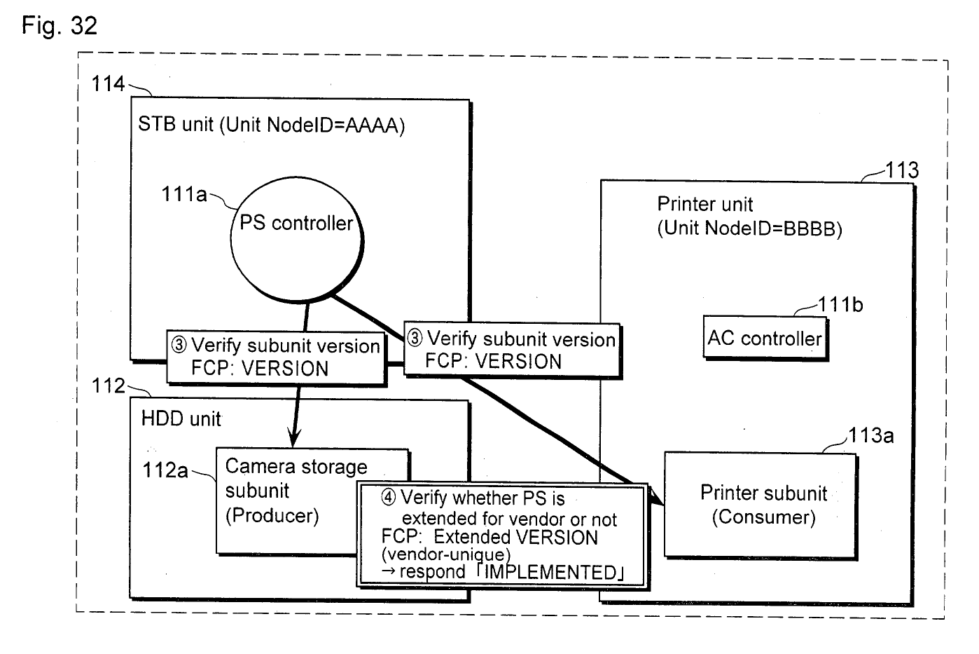

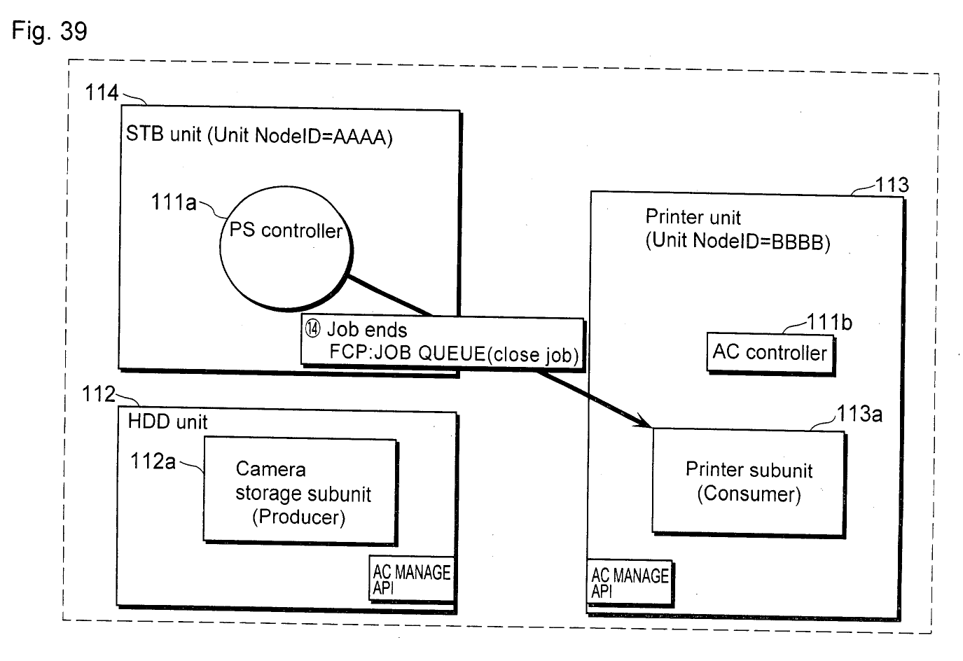

FIG. 31˜FIG. 39 are flowcharts showing exchanges of commands between three devices (an STB unit 114, a printer unit 113 and an HDD unit 112) in the case where the printer unit has a function as an AC controller, that is, when the printer unit is in a position to establish Asynchronous Connection with the data supply unit. These figures are same as FIG. 7˜FIG. 14 in a diagram form. In these figures, “AC MANAGE API” is an interface for managing Asynchronous Connection (Application Program Interface), and “EUI_{—}64” represents “64-bit extended unique identifier” (defined by Institute of Electrical and Electronics Engineers (IEEE)).

Comparison between FIG. 31˜FIG. 39 and FIG. 7˜FIG. 14 shows that the communication sequence in the case where the printer unit 113 has a function as an AC controller is different from that in the case where the STB unit 114 has a function as an AC controller in the following points.

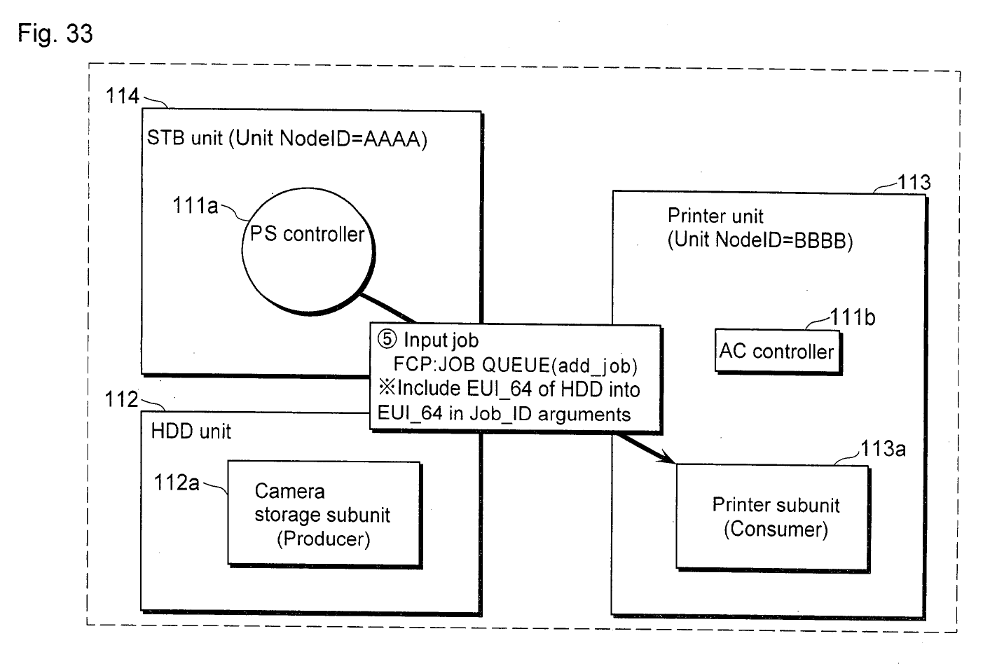

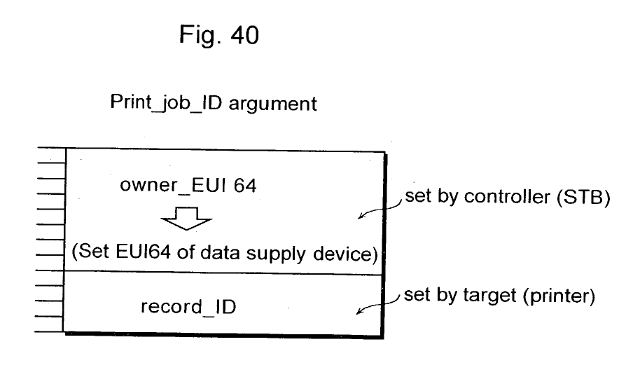

First, when inputting a print job into the printer unit 113 (Step 5 in FIG. 33), the STB unit 114 sets “EUI_{—}64” of the print data supply device (the HDD unit 112 in this embodiment) as an internal “EUI_{—}64” of “job_ID” (print_job_ID) argument for issuance of JobQueue command. Here, “job_ID” argument having a data structure shown in FIG. 40 is one of the JobQueue command arguments, and includes “EUI_{—}64” of 8 bytes long (usually, “EUI_{—}64 of a sender of JobQueue command (“owner_EUI64”) and “record_ID” of 4 bytes long (response to JobQueue command).

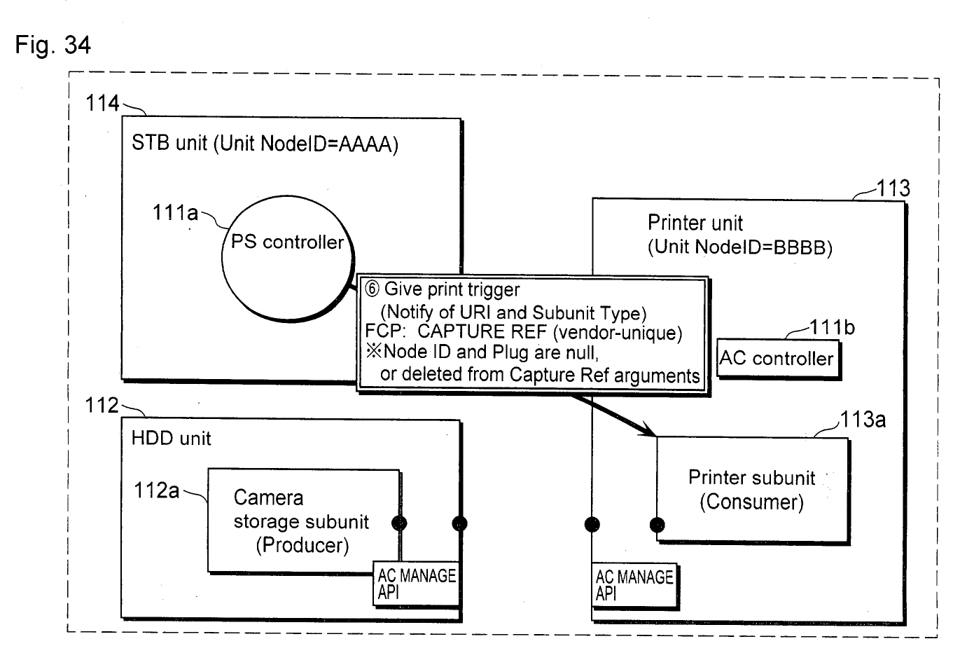

After issuing JobQueue command, the STB unit 114 issues the print command CAPTURE REF to the printer unit 113 as a print trigger without establishing a connection (because it has no function of establishing a connection) (Step 6 in FIG. 34). At this time, null values are designated as the parameters “node_ID (producer_node_ID), “source_plug” and “destination_plug” in the print command CAPTURE REF.

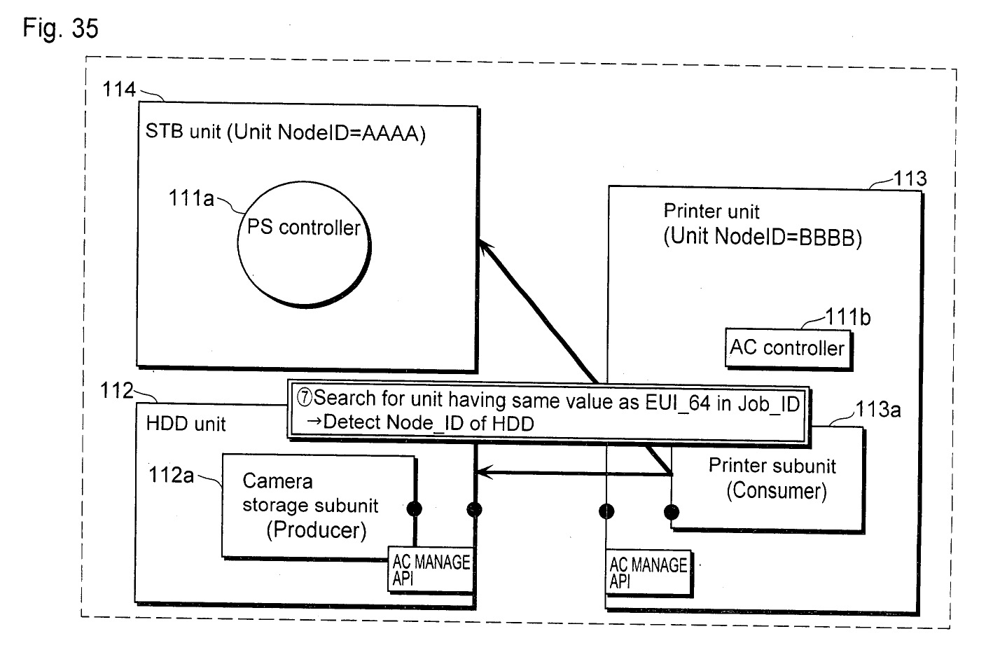

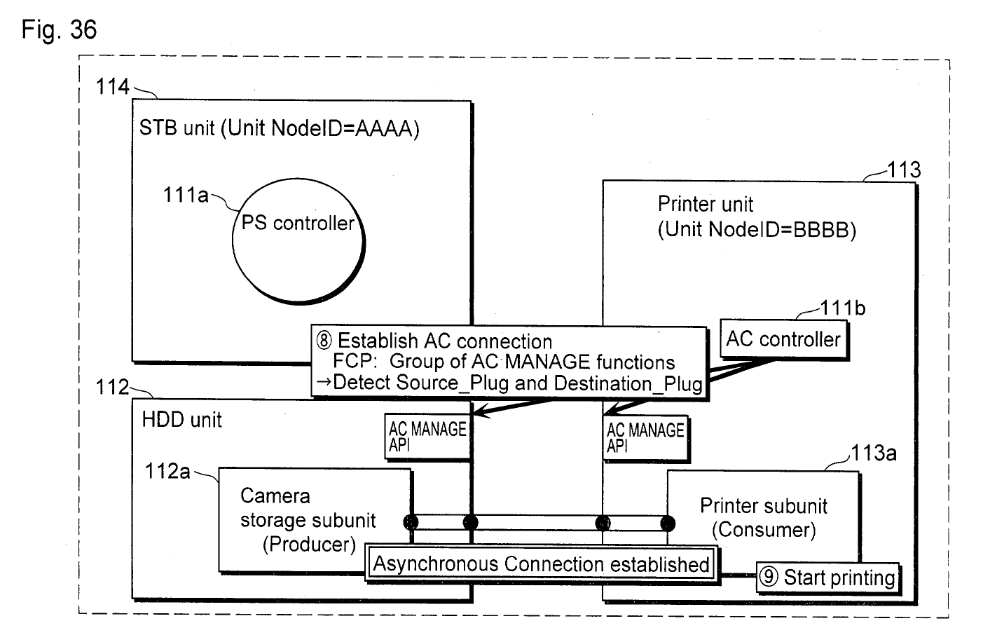

Upon receipt of the print command CAPTURE REF, the printer unit 113 fetches “EUI_{—}64” of the HDD unit 112 from among “job_ID” arguments and searches for “node_ID” having the same value as the value of that “EUI_{—}64” for acquisition of “node_ID” of the HDD unit 112 (location information specifying the print data supply device) (Step 7 in FIG. 35). Then, the AC controller 111b in the printer unit 113 establishes the connection between the HDD unit 112 and the printer unit 113 for obtaining the values of “source_plug” and “destination_plug” which were null in the print command CAPTURE REF (Step 8 in FIG. 36).

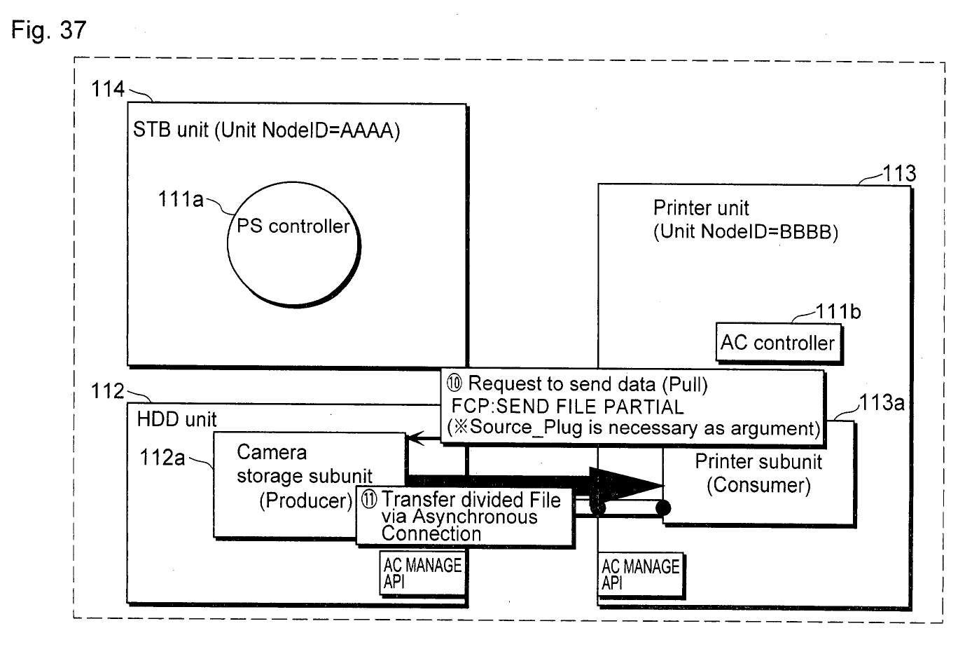

In this manner, after the print data supply device (“producer_node_ID”) and the plug (“source_plug” and “destination_plug”) are detected, the data is transferred in the same steps shown in FIG. 12 (Steps 10 and 11 in FIG. 37). Also, the printer unit 113 returns ACCEPTED in response to the print command CAPTURE REF to the STB unit 114 after finishing the data transfer, in the same manner.

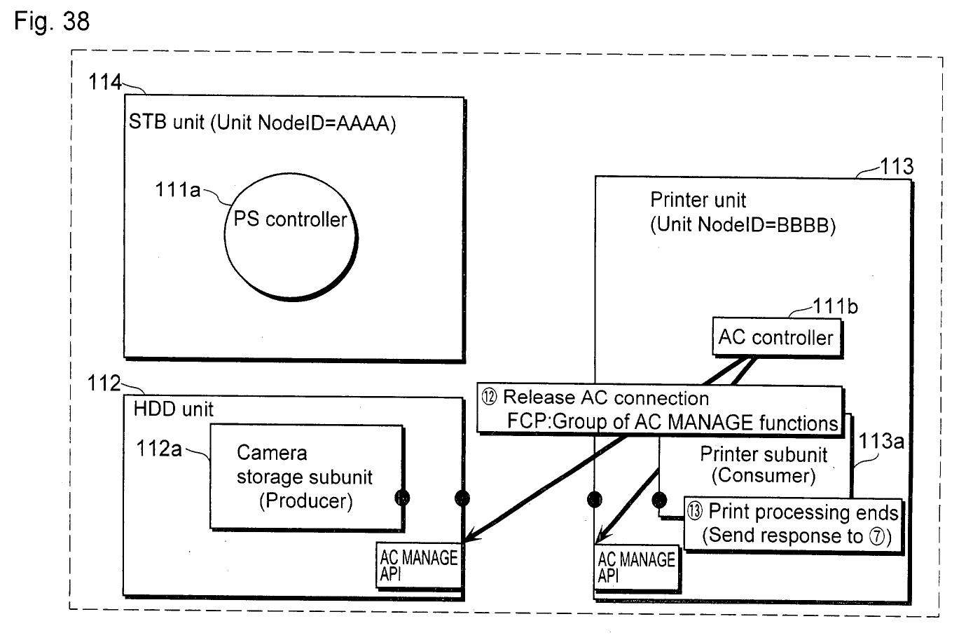

However, the AC controller 111b in the printer unit 113 releases the connection (Step 12 in FIG. 38).

Even if the printer unit has a function as an AC controller, in the same manner as the case where the STB unit has a function as an AC controller, these steps as mentioned above make pull-type printing possible in the case where the device which issues a print instruction is different from the device which holds print objects.

When the printer unit has an AC controller, the STB unit may send a print command by designating all the parameters for specifying the print data supply device “producer_node_ID”, “source_plug”, “subunit_type”, “subunit_ID” null or without attaching these parameters to the command. In such a case, the printer unit may acquire the values of the parameters “producer_node_ID”. “source_plug”, “subunit_type” and “subunit_ID” by issuing STATUS command of AC MANAGE FCP to the print data supply device (such as the HDD unit) connected to the printer unit via the connection, and transfer (acquire) the data based on the acquired values.

In other words, the printer unit acquires address information which specifies a destination of a file request by inquiring the connection status of the print data supply device connected to the printer unit via the connection, and issues the file request to the destination indicated by the acquired address information. Even this step makes it possible to execute the pull-type printing of print objects placed in the device (HDD unit) different from the device which issues a print instruction (STB unit).

As concrete examples of a controller, a data transmission device (producer) and a data reception device (consumer) included in the printing system, the present embodiments show STB, an HDD device and a printer unit respectively. However, in addition to these devices, the controller may be a computer device, a home bus controller or the like, the data transmission device may be a DSC, DTV or DVD (Digital Versatile Disk) device, a video camera device or the like, and the data reception device may be a mass storage device which stores print objects, a communication device or the like which transfers the print objects to remote locations.

Also, in the present embodiments, one print command CAPTURE REF is sent from the controller to the printer unit as a print trigger, but the command may be divided into two or more print commands. For example, the step may be followed to issue the basic print command including the parameters (shown in FIG. 5A) irrelevant to the print data supply device (Producer) first and then issue the extended print command including the parameters (“producer_node_ID”, “source_plug”, “subunit_type”, “subunit_ID” and “object_path” shown in FIG. 5B) relevant to the print data supply device (Producer).

The command CAPTURE REF parameter “object_path” shown in FIGS. 5B and 5C and the command CAPTURE REF parameter “base_path” shown in FIG. 5C have “variable” and arbitrary data lengths, but they are limited to up to 512 bytes for one command according to the current AV/C command. Therefore, if a restriction is put that only one command CAPTURE REF is used for one print request, the maximum length of the parameter “object_path” or “base_path” needs to be limited to some extent in view of the balance between these parameters and the other parameters of the command CAPTURE REF. On the other hand, when a plurality of commands CAPTURE REF can be used for one print request, there is no particular restriction on the length of the parameter “object_path” or “base_path”. There will be no particular mention here about the details of how to use a plurality of commands CAPTURE REF for one print request. However, for example, a parameter for specifying the total number of commands CAPTURE REF which are issued for the print request and a parameter for specifying the issuance sequence may be newly added to the command CAPTURE REF so that the printer subunit 13a is notified of the divided parameter “object_path”.

The printing system of the present embodiments includes devices which are connected to each other by an IEEE1394 bus, but a transmission channel for connecting the devices is not limited to this bus. The print procedure according to the present invention can be applied to a communication system having LAN (10BaseT or the like), the Internet, Bluetooth® or the like in the lower layer, if a print command, a file capture command and the like can be sent and received through the communication system.

Next, secondary effects produced by application of the present embodiments will be described.

The conventional IEEE1394 AV/C Printer Subunit does not support pull-type print mode, but supports push-type print mode only. The conventional one is also based on the premise of printing image data. Therefore, in order to print a print object including a plurality of files which are linked to each other, such as a print object described in HTML (Hyper Text Markup Language), it is the only way that a print data supply device generates one image data before data transfer. The print data supply device requires a lot of processing capabilities and memory resources.

On the other hand, when it is possible to print the print object described in HTML in push-type print mode, the print object is transferred (pushed) as it is to the printer device, which generates image data for printing. Even in this case, since the print object needs to be transferred (pushed) in each page, there is a problem that the printer device requires a mass storage buffer for storing the print object for one page. Also, since the controller needs to perform output control such as monitoring the print status of the printer device and outputting the print object depending upon the print progress, there is a problem that heavy processing load is put on the controller.

However, the present embodiments make it possible to perform pull-type printing of an HTML file by the capture command of AV/C printer command in IEEE1394, and therefore solve the problems that the printer device requires a mass storage buffer for storing a print object for one page, heavy processing load is put on the controller, and the print data supply device requires a lot of memory and processing capabilities.

The controller 11 of the present embodiments may be a single device itself, or may be a same device as a print data supply device or a printer device. The print instruction which the printer device receives includes specification of a location for storing a print object (the print data supply device), and upon receipt of the print instruction, the printer device acquires the print object stored in the specified location for printing (pull-type printing). Therefore, it is possible to print the print object not only when the device which issues a print instruction is same as the device which holds the print object but also when those devices are different. In other word, even if the print object is placed in the location (print data supply device) different from the print control device which issues the print instruction, that print object can be printed, and therefore, the printing system can be realized so as to make effective use of the functions of the pull-type printer device.

As described above, the printing system according to the present embodiments make it possible to realize flexible printing depending on a variety of system configurations such as printing of a print object stored in a location different from a controller (an independent print data supply device).

Also, in the pull-type print mode, a printer device needs to issue a data send command to a print data supply device in order to receive (pull) print data. In order to issue the data send command, the printer device has to obtain information in advance such as a location (an address) of the print data supply device, a command system and parameters for the data send command.

However, according to the present embodiments, this information can be easily obtained if this information is included into a command CAPTURE REF of AV/C Printer Subunit, or the printer device inquires the status of the connection established between the printer device and the print data supply device.

Accordingly, when the command system, sequence and others on sending and receiving information depend on the type of the print data supply device, the printer device can acquire, in recognition of the differences thereof, the print object according to the protocol suitable for the characteristics of the print data supply device, and therefore it becomes possible to improve the efficiency for transfer and print processing of the print object.

Furthermore, in the IEEE1394 standard, effects of bus reset inherent to the IEEE1394 standard needs to be considered for the address of the print data supply device. The bus reset occurs when the device on the IEEE1394 network is turned on or off or a cable is connected or disconnected. When the bus reset occurs, the address of the device on the network is reset. Therefore, when the printer device detects bus reset, it needs to obtain a new address of the print data supply device.

In the present embodiments, the address on the IEEE1394 transmission channel is reset, the connection is restored between the print data supply device and the printer device, the print request is resent to the printer device, and in response to the resent request, the printer device resumes receiving data necessary for the requested printing. After that, a value based on the address information of the print data supply device after the bus reset is set for a parameter for setting the location of the device in the method of including the location (address) of the device and the like into the command CAPTURE REF, while the status of the connection is inquired after receiving the resent request in the method of inquiring the status thereof. Accordingly, a correct value can be easily obtained even after the bus reset.

Furthermore, in a document described in HTML or the like, links to other print objects (link path information) are described. When this link path information is a relative path specifying a location of a file based on the relative location thereof from a reference point, the relative path needs to be converted into an absolute path specifying a file based on the absolute location thereof. In the present embodiments, the absolute path can be easily obtained using the first˜third methods for solving the path.

As obviously described above, the present invention is a method for transferring print data between a print data supply device and a printer device which are connected to each other via a transmission channel, and the method includes: a step for requesting the printer device to print print data held by the print data supply device of which attribute information is attached to the print request; a step in which, in response to the print request, the printer device requests the print data supply device to transmit the print data based on the attribute information; and a step in which, in response to the data request, the print data supply device transmits the print data to the printer device.

Accordingly, the print data transfer method or the like to which the present invention is applied makes it possible to realize a pull-type print mode (Pull Print) in which printing is executed based on the data transfer request from the printer device, and therefore the practical value of this method is extremely high. Also, the print file acquisition system or the like according to the present invention makes it possible to acquire a file even when the link path information is a relative path. Furthermore, the data transfer method or the like according to the present invention makes it possible to acquire correct data even at bus reset.

### INDUSTRIAL APPLICABILITY

The print data transfer method or the like according to the present invention can be used as a method for transferring print data to a printer device, and particularly it is applicable to a pull-type printing system in which the printer device can request a print data supplier to supply the print data.

1. A method for transferring print data between a print data supply device and a printer device which are connected to each other via a transmission channel, the method comprising:
a step for requesting the printer device to print print data held by the print data supply device of which attribute information is attached to the print request;
a step in which, in response to the print request, the printer device requests the print data supply device to transmit the print data based on the attribute information; and
a step in which, in response to the data request, the print data supply device transmits the print data to the printer device.

2. The method according to claim 1,
wherein the attribute information is attribute information of the print data held by the print data supply device, and link path information of print data to be printed.

3. The method according to claim 2, further comprising a step for setting a reference location of the link path information for the print data supply device.

4. The method according to claim 3,
wherein the reference location is set for a respective connection.

5. The method according to claim 3,
wherein the print data supply device notifies that the reference location is changed, with a response to the data request.

6. The method according to claim 5,
wherein the print data supply device includes a detachable recording medium, and notifies that the reference location is changed, using a parameter indicating that the recording medium is attached.

7. The method according to claim 3,
wherein the reference location of the link path information is set for the print data supply device before the print request is issued to the printer device, and
the setting of the reference location is not changed until a completion notice in response to the print request is received.

8. The method according to claim 1,
wherein when either one of the link path information included in the attribute information and link path information described in the print data is a relative path indicating a location from a reference location, the reference location of the link path information is further included in the attribute information.

9. The method according to claim 8,
wherein the printer device holds the reference location of the link path information which is received as the attribute information in the step for the print request until sending a completion notice in response to the print request.

10. The method according to claim 8,
wherein the reference location of the link path information described in the print data is extracted from the link path information included in the attribute information in the print request.

11. The method according to claim 10,
wherein the printer device holds the reference location of the link path information which is extracted from the link path information included in the attribute information in the print request until sending the completion notice in response to the print request.

12. The method according to claim 1,
wherein the printer device receives a link file in which link path information of print data to be printed is described, and requests the print data supply device to transmit the print data specified with the link path information described in the link file.

13. The method according to claim 1,
wherein the data request and the data transmission are repeated.

14. The method according to claim 1,
wherein the data transmission is carried out via a connection which has been established in advance.

15. The method according to claim 14,
wherein all or a part of the attribute information is acquired by inquiring status of the connection established between the print data supply device and the printer device.

16. The method according to claim 14,
wherein the connection is established by the printer device.

17. The method according to claim 14,
wherein the connection is established by a print control device other than the print data supply device and the printer device.

18. The method according to claim 14,
wherein the transmission channel is IEEE1394, and
the connection complies with Enhanced Asynchronous Serial Bus Connections in IEEE1394.

19. The method according to claim 14,
wherein the attribute information is connection information which specifies an input port on the part of the print data supply device on the connection.

20. The method according to claim 19,
wherein the connection information is Subunit_plug_ID in IEEE1394 AV/C Standard.

21. The method according to claim 1,
wherein the attribute information is address information for specifying the print data supply device.

22. The method according to claim 21,
wherein the address information is either one of Node_ID and EUI_{—}64 in IEEE1394 AV/C Standard.

23. The method according to claim 21,
wherein the address information is a combination between either one of Node_ID and EUI_{—}64 in IEEE1394 AV/C Standard and Subunit_type and Subunit_ID in IEEE1394 AV/C Standard.

24. The method according to claim 1,
wherein the attribute information is type information which specifies a type of the print data supply device.

25. The method according to claim 24,
wherein the type information is Subunit_type in IEEE1394 AV/C Standard.

26. The method according to claim 1,
wherein the printer device receives the print request from a print control device other than the print data supply device.

27. The method according to claim 1,
wherein the printer device sends a completion notice in response to the print request after completing reception of data necessary for the requested printing.

28. The method according to claim 1,
wherein the printer device sends the completion notice in response to the print request after the printer device does not need to receive the print data which is requested for printing and print data which is further referred to by the print data.

29. The method according to claim 1,
wherein the print request includes a first group of parameters which are irrelevant to the print data supply device and a second group of parameters which are relevant to the print data supply device.

30. The method according to claim 29,
wherein the print request is one command including the first group of parameters and the second group of parameters.

31. The method according to claim 29,
wherein the print request is divided into a first command including the first group of parameters and a second command including the second group of parameters.

32. The method according to claim 1,
wherein when an address on the transmission channel is reset, a connection between the print data supply device and the printer device is restored, and then, the print request is retransmitted to the printer device, and
in response to the retransmitted print request, the printer device resumes reception of data necessary for the requested printing.

33. The method according to claim 32,
wherein the retransmitted print request is based on address information of the print data supply device obtained after bus reset.

34. The method according to claim 1,
wherein the attribute information includes, out of the print data held by the print data supply device, first link path information which specifies a storage location of first print data to be printed with an absolute path, and a reference location of a relative path indicating a storage location of second print data which is referred to by the first print data.

35. The method according to claim 1, further comprising a step for verifying, prior to the print request, whether or not the print data supply device which holds the print data and the printer device which prints the print data are connected to the transmission channel, and notifying a user of an error if at least one of the print data supply device and the printer device is not connected to the transmission channel.

36. The method according to claim 1,
wherein the print request to the printer device includes an inquiry about whether the printer device has a function of requesting the print data supply device to transmit the print data, and
the method further includes a step in which the printer device responds to the inquiry.

37. The method according to claim 36,
wherein when the printer device responds to the inquiry that the printer device does not have the function, the print data supply device transmits the print data to the printer device without receiving the data request from the printer device.

38. The method according to claim 36, further comprising a step for notifying a user of an error when the printer device responds to the inquiry that the printer device does not have the function and only the printer device having the function can print print data to be printed.

39. The method according to claim 1, further comprising a printing type determining step for inquiring, prior to the print request, status of at least one of the print data supply device and the printer device, and determining whether pull-type printing is carried out or push-type printing is carried out depending on the response to the inquiry,
wherein in the pull-type printing, the printer device prints the print data while requesting the print data from the print data supply device, and in the push-type printing, the printer device prints the print data transmitted from the print data supply device without requesting the print data.

40. The method according to claim 39,
wherein in the printing type determining step, a size of a data reception buffer included in the printer device is compared with a size of print data to be printed, and
when the size of the data reception buffer is larger than the size of the print data, it is determined that the push-type printing is carried out, and when the size of the data reception buffer is not larger than the size of the print data, it is determined that the pull-type printing is carried out.

41. A printing system comprising a print data supply device and a printer device which are connected to each other via a transmission channel,
wherein the print data supply device holds print data, and
the printer device includes:
a unit operable to receive a print request which is issued together with attribute information of the print data supply device in order to print the print data held by the print data supply device;
a unit operable to request, in response to the print request, the print data supply device to transmit the print data based on the attribute information;
a unit operable to receive the print data which is transmitted from the print data supply device in response to the data request; and
a unit operable to print the print data.

42. The printing system according to claim 41,
wherein the printer device further includes a unit operable to receive a link file in which link path information of print data to be printed is described, and
the data request unit requests the print data supply device to transmit the print data specified with the link path information described in the link file.

43. The printing system according to claim 41,
wherein the print data transmitted from the print data supply device is received via a connection which has been established in advance.

44. The printing system according to claim 41,
wherein the attribute information is address information for specifying the print data supply device.

45. The printing system according to claim 41,
wherein the attribute information is type information which specifies a type of the print data supply device.

46. The printing system according to claim 41,
wherein the printer device receives the print request from a print control device other than the print data supply device.

47. The printing system according to claim 41,
wherein the printer device sends a completion notice in response to the print request after completing reception of data necessary for the requested printing.

48. The printing system according to claim 41,
wherein when an address on the transmission channel is reset, the connection between the print data supply device and the printer device is restored, and then, the print request is retransmitted to the printer device, and
in response to the retransmitted print request, the printer device resumes reception of data necessary for the requested printing.

49. A printer device which is connected with a print data supply device which holds print data via a transmission channel, the printer device comprising:
a unit operable to receive a print request which is issued together with attribute information of the print data supply device in order to print the print data held by the print data supply device;
a unit operable to request, in response to the print request, the print data supply device to transmit the print data based on the attribute information;
a unit operable to receive the print data which is transmitted from the print data supply device in response to the data request; and
a unit operable to print the print data.

50. The printer device according to claim 49, further comprising a unit operable to receive a link file in which link path information of print data to be printed is described, and
the data request unit requests the print data supply device to transmit the print data specified with the link path information described in the link file.

51. The printer device according to claim 49,
wherein the print data transmitted from the print data supply device is received via a connection which has been established in advance.

52. The printer device according to claim 49,
wherein the attribute information is address information for specifying the print data supply device.

53. The printer device according to claim 49,
wherein the attribute information is type information which specifies a type of the print data supply device.

54. The printer device according to claim 49 receives the print request from a print control device other than the print data supply device.

55. The printer device according to claim 49 sends a completion notice in response to the print request after completing reception of data necessary for the requested printing.

56. The printer device according to claim 49,
wherein when an address on the transmission channel is reset, the printer device re-receives the print request after the connection between the print data supply device and the printer device is restored, and
in response to the retransmitted print request, resumes reception of data necessary for the requested printing.

57. A program for a printer device that forms an image based on received print data, the program causing a computer to function as:
a unit operable to receive a print request which is issued together with attribute information of the print data supply device in order to print the print data held by the print data supply device;
a unit operable to request, in response to the print request, the print data supply device to transmit the print data based on the attribute information;
a unit operable to receive the print data which is transmitted from the print data supply device in response to the data request; and
a unit operable to print the print data.

58. A print file acquisition system comprising:
a storage unit operable to store link path information which specifies a storage location of a print file;
a conversion unit operable to convert a relative path into an absolute path when all or a part of the link path information acquired from the storage unit is the relative path, the relative path indicating a relative location of the print file from a predetermined reference location and the absolute path indicating an absolute location of the print file; and
an acquisition unit operable to acquire the print file, the print file being able to be specified with the absolute path obtained by the conversion by the conversion unit.

59. A print data transfer system comprising a print data supply device and a printer device which are connected to each other via a transmission channel, for transferring print data from the print data supply device to the printer device, the system further comprising:
a network information acquisition unit operable to acquire network connection information of the print data supply device and the printer device after bus reset;
a connection restoration unit operable to restore the connection for the print data transfer between the print data supply device and the printer device based on the network connection information obtained from the network information acquisition unit;
a print request retransmission unit operable to retransmit a print request based on the network connection information obtained from the network information acquisition unit; and
an acquisition unit operable to acquire a print object based on the print request retransmitted by the print request retransmission unit.
